(19) United States
(12) Patent Application Publication
(10) Pub. No.: US 2026/0278341 A1
(43) Pub. Date: Sep. 17, 2026

(54) SYSTEM

(71) Applicant: SoftBank Group Corp., Tokyo (JP)

(72) Inventor: Yoshiki KANEHARA, Tokyo (JP)

(73) Assignee: SoftBank Group Corp., Tokyo (JP)

(21) Appl. No.: 19/547,714

(22) Filed: Feb. 24, 2026

Related U.S. Application Data
(60) Provisional application No. 63/769,930, filed on Mar. 11, 2025.

(51) Int. Cl. G06N 3/0455; G06F 18/241; G06F 40/30; G06N 3/0475; H04L 51/02

(52) U.S. Cl. CPC G06N 3/0455; G06F 18/241; G06N 3/0475; H04L 51/02; G06F 40/30

(57) ABSTRACT

A system includes a processor that is configured to collect data from a plurality of information sources on the Internet, perform natural language processing on the collected data to analyze the collected data and extract important keywords and phrases from the collected data, evaluate a reliability of information included in the collected data by using a deep learning algorithm, provide evaluated information to a user, evaluate the reliability of the information by taking into account at least a source of the information, consistency of content of the information, a past reliability evaluation of the information or of the source, and an update frequency of the information, provide, to the user, information that is determined to have high reliability without modification, and display a warning for information that is determined to have low reliability and provide a detailed explanation regarding the reliability of the information.

### CROSS-REFERENCE TO RELATED APPLICATION

This application claims the benefit of U.S. Provisional Application No. 63/769,930, filed on Mar. 11, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information distribution systems on the Internet merely collect and present information from various online sources without adequately evaluating the reliability of such information. As a result, users are frequently exposed to misinformation, rumors, and biased content originating from low-reliability sources, which makes it difficult for users to determine which information can be trusted. In particular, existing systems do not sufficiently integrate automated natural language processing, deep learning-based reliability evaluation, and user-facing presentation of reliability indicators and explanations. Therefore, there is a need for a system that can automatically collect data from multiple heterogeneous online sources, analyze the content of the collected data, evaluate the reliability of the information based on multiple factors including source characteristics and content consistency, and provide the user with both reliable information and clear warnings and explanations for information that may be unreliable.

### SUMMARY

In order to solve the above-described problem, according to one aspect of the present invention, there is provided a system comprising a processor, wherein the processor is configured to collect data from a plurality of information sources on the Internet, perform natural language processing on the collected data to analyze the collected data and extract important keywords and phrases, evaluate a reliability of information included in the collected data by using a deep learning algorithm, and provide evaluated information to a user. The processor is further configured to evaluate the reliability of the information by taking into account at least a source of the information, consistency of content of the information, a past reliability evaluation of the information or of the source, and an update frequency of the information, and to provide, to the user, information that is determined to have high reliability without modification, while displaying a warning for information that is determined to have low reliability and providing a detailed explanation regarding the reliability of the information. In one embodiment, the processor is configured to use a web crawler to periodically collect the data from a plurality of information sources including at least news sites, social media platforms, blogs, and forums, and to perform tokenization of text, part-of-speech tagging, and syntactic analysis of sentences to mechanically understand content of the information. In another embodiment, the processor is configured to use a deep learning algorithm trained on past data to evaluate the reliability of the information, to perform cross-referencing when there is a possibility that the information is false, and to provide related information from other reliable information sources together with warnings for low-reliability information.

The term “system” refers to an arrangement of one or more hardware and software components that cooperatively perform the functions described in the present specification and claims.

The term “processor” refers to one or more hardware processing units, such as a central processing unit (CPU), a graphics processing unit (GPU), a digital signal processor (DSP), a microcontroller, or any combination thereof, configured to execute instructions to perform the operations described in the present specification and claims.

The term “Internet” refers to a global network of interconnected computers and communication devices that communicate using standardized protocols to provide access to remote servers, websites, services, and other network resources.

The term “information source” refers to any online service, site, platform, or server that provides data accessible via the Internet, including but not limited to news sites, social media platforms, blogs, and forums.

The term “data” refers to digital information obtained from one or more information sources, including text, metadata, and any associated attributes that can be processed by the system.

The term “natural language processing” refers to a set of computational techniques and algorithms for analyzing and understanding human language text, including but not limited to tokenization, part-of-speech tagging, syntactic analysis, semantic analysis, sentiment analysis, and keyword extraction.

The term “keywords and phrases” refers to words, multi-word expressions, or linguistic units that are automatically identified as being important or representative for characterizing the content or topic of a given text.

The term “evaluate a reliability of information” refers to determining, by computational means, a degree or score indicative of how likely the information is to be accurate, trustworthy, and free from false or misleading content.

The term “deep learning algorithm” refers to a machine learning model comprising multiple layers of processing units, such as a neural network with two or more hidden layers, trained on data to perform tasks including, but not limited to, classification, regression, or scoring of information reliability.

The term “source of the information” refers to an origin entity or channel from which a given piece of information is obtained, including but not limited to a specific website, domain, organization, publisher, platform, or user account.

The term “consistency of content” refers to a degree of agreement or alignment between a given piece of information and other pieces of information that are considered reliable, including the absence of significant contradictions or unsupported deviations.

The term “past reliability evaluation” refers to one or more previously determined reliability scores, ratings, or judgments associated with information or information sources, which are used as historical indicators of trustworthiness.

The term “update frequency of the information” refers to how often information or its underlying source content is changed, revised, or updated over time, including the temporal pattern of such updates.

The term “web crawler” refers to software that automatically navigates across web pages and online resources by following links or using predetermined URLs in order to collect data from a plurality of information sources.

The term “news sites” refers to online services or websites that primarily provide news articles, reports, or bulletins about current events, including but not limited to general news portals and specialized news outlets.

The term “social media platforms” refers to online services that enable users to create, share, and interact with content and with each other, such as microblogging services, social networking services, and content-sharing platforms.

The term “blogs” refers to websites or web pages that present articles, posts, or entries typically authored by individuals or groups, often organized chronologically and frequently including commentary or opinion on specific topics.

The term “forums” refers to online discussion sites or message boards where multiple users can post messages, questions, and responses, typically organized into threads and topics.

The term “tokenization of text” refers to a process of segmenting a text into discrete units such as words, subwords, symbols, or punctuation marks for subsequent natural language processing.

The term “part-of-speech tagging” refers to assigning grammatical category labels, such as noun, verb, adjective, or adverb, to each token in a text based on its role in the sentence.

The term “syntactic analysis” refers to determining the grammatical structure of a sentence, including relationships between words and phrases, using methods such as dependency parsing or constituency parsing.

The term “mechanically understand content of the information” refers to automatically processing and interpreting text using computational methods so that the system can derive structured representations, features, or semantic information from the text without human intervention.

The term “cross-referencing” refers to comparing a given piece of information with other information obtained from different information sources in order to confirm, refute, or refine the reliability assessment of the given piece of information.

The term “false information” refers to information that is inaccurate, misleading, fabricated, or otherwise not in accordance with verifiable facts, including misinformation and disinformation.

The term “evaluated information” refers to information for which the system has determined a reliability score or level based on the deep learning algorithm and other factors described in the present specification and claims.

The term “warning” refers to a message or indication presented to a user that alerts the user to the possibility that certain information may be unreliable or of low trustworthiness.

The term “detailed explanation regarding the reliability of the information” refers to text or other content provided to a user that describes one or more reasons, factors, or evidentiary bases underlying the reliability evaluation of the information.

The term “related information from other reliable information sources” refers to additional data, articles, posts, or references obtained from information sources that are assessed to have relatively high reliability and that pertain to the same or similar topic as the original information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

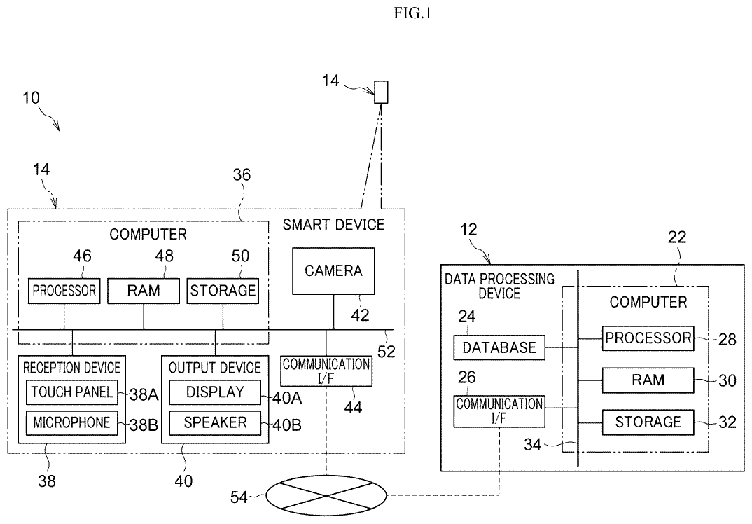

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

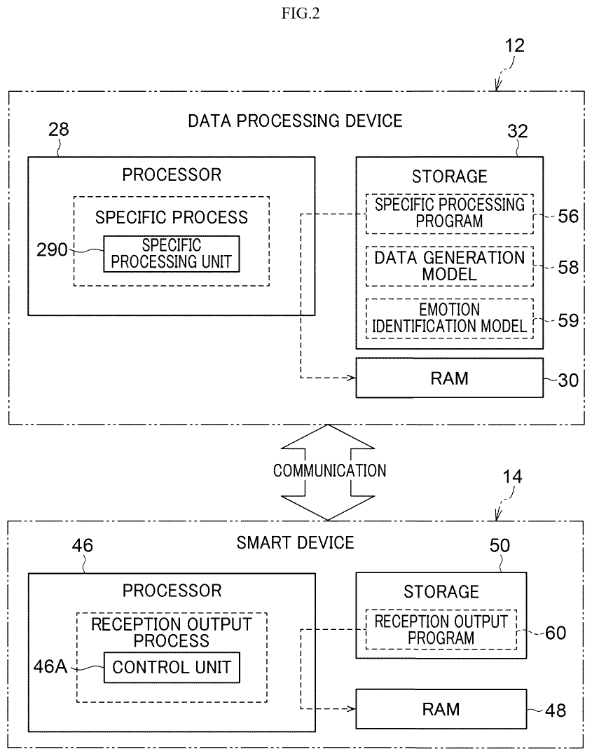

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems that collect content from networked information sources and present such content to end users suffer from several technical drawbacks at the level of computer operation. First, many systems perform reliability evaluation using fixed heuristic rules or shallow statistics, which produces reliability scores that are difficult to interpret and cannot be robustly adapted as the distribution of sources and content changes over time. As a result, the computing resources of the server, including processors, memory, and network bandwidth, are consumed to store and transmit large volumes of low-value or misleading data, and the internal models used for filtering and ranking become stale without an efficient mechanism for continuous refinement. Second, existing systems typically treat natural language understanding, reliability assessment, and explanation generation as disjoint processes. Even when machine learning models are employed, the system often lacks an integrated architecture for: (i) constructing feature sets that capture cross-source semantic relationships between documents; (ii) using those feature sets in a trained deep learning model to compute reliability indices; and (iii) feeding both the reliability indices and their underlying feature-level rationale to a generative AI model through structured prompt sentences. This separation leads to redundant computations, increased latency, and storage of inconsistent metadata across multiple components, thereby degrading the overall efficiency and scalability of the information processing pipeline.

Third, conventional systems provide limited technical support for incorporating user feedback into the core reliability evaluation process. User reactions such as “this information seems incorrect” or “this source is trustworthy” are often handled only at the presentation layer and are not integrated as structured training signals into the models that operate at the server. Consequently, the server cannot systematically exploit feedback to recalibrate reliability indices, update cross-reference features, or refine the prompts used for generative AI models. This undermines the adaptability of the system to new misinformation patterns and emerging sources, and results in suboptimal use of computational resources for model training and inference.

Fourth, explanation generation in many systems is either static or manually authored, and does not leverage the detailed, machine-readable context already computed during reliability evaluation. Without a mechanism to construct structured prompt sentences that encode topic classifications, key terms, reliability indices, cross-reference information, and user feedback, generative AI models cannot be effectively guided to produce concise, accurate, and consistent explanations. This leads to increased processing time, higher token usage, and inconsistent explanations across similar documents, which in turn increases load on the server and reduces the determinism and reliability of AI-generated outputs.

Accordingly, there is a need for an improved computer-implemented system and method that, on a server, (i) systematically collects and structurally annotates document data from multiple information sources, (ii) constructs feature sets capturing cross-document and cross-source relationships, (iii) uses a trained deep learning model to compute reliability indices, (iv) generates structured prompt sentences for a generative AI model based on those indices and features, and (v) incorporates user feedback as training data to update both the deep learning model and the prompt generation logic. Such an architecture should reduce redundant computations, improve the efficiency and accuracy of reliability evaluation and explanation generation, and enable more effective allocation of processing and network resources.

The specific processing by the specific processing unit 290 of the data processing device 12 in Example 1 is realized by the following means.

The present invention provides a server comprising a processor configured to acquire document data and associated metadata from a plurality of information sources via a communication network, normalize and segment the document data to generate structured data including linguistic annotations, derive, from the structured data, topic classification information, feature term information, emotional state information, stance information, and cross-document similarity information, construct for each document data a feature set including at least source history information, similarity information, update history information, content consistency information, and user feedback information, input the feature set into a trained deep learning model to calculate a reliability index and reliability classification information for the document data, generate for each document data a structured prompt sentence for a generative AI model, the prompt sentence including at least the topic classification information, the feature term information, the reliability index, cross-reference information, and explanation tag information, transmit the prompt sentence to the generative AI model and receive summary information and explanation information therefrom, associate the summary information and the explanation information as generative output with the corresponding document data, generate response data including selected document data, the associated reliability index, and the associated generative output based on user attribute information and user selection conditions, transmit the response data to a user terminal via the communication network, and record and aggregate evaluation feedback information received from the user terminal and use the aggregated evaluation feedback information as training data to update at least one of the trained deep learning model and a process for generating the structured prompt sentence. This enables an integrated and adaptive server-side information processing pipeline in which reliability evaluation, generative explanation, and user feedback are tightly coupled at the feature and model levels, thereby improving computational efficiency, scalability, and accuracy of reliability indices and explanations while reducing redundant processing and network usage in comparison with conventional systems.

The term “system” refers to a combination of hardware and software components that cooperatively execute one or more processes to implement the functions described herein. The term “server” refers to an electronic device, or a group of electronic devices, including at least one processor and a memory, configured to provide data processing services via a communication network to one or more client devices.

The term “processor” refers to a hardware processing unit, such as a central processing unit or a specialized processing circuit, that executes instructions to perform arithmetic, logical, control, or input/output operations required to implement the methods described herein.

The term “communication network” refers to any wired or wireless data communication infrastructure, including local area networks, wide area networks, and public networks, that enables exchange of data between the server, information sources, and user terminals.

The term “information source” refers to an external system, service, or storage entity accessible via the communication network, from which document data and metadata can be obtained, including but not limited to content distribution services, social communication services, and user-generated content platforms.

The term “document data” refers to electronic data representing content, including text data and optionally associated media or metadata, that is acquired from an information source and processed by the server.

The term “metadata” refers to information associated with document data, including but not limited to time information, source identification information, category information, and user interaction information, that describes properties or context of the document data.

The term “acquisition time information” refers to temporal data indicating a time at which the server obtained particular document data from an information source.

The term “source identification information” refers to data that uniquely or distinguishably identifies an information source from which document data was obtained.

The term “storage device” refers to a hardware component or subsystem, such as a memory device or persistent storage medium, configured to store document data, metadata, intermediate processing results, and model parameters.

The term “preprocessing” refers to a set of operations performed on raw document data to convert the data into a standardized and machine-processable form, including but not limited to character code normalization, symbol removal, and segmentation.

The term “character code normalization” refers to a process for converting character encodings or representations in document data to a unified or canonical format to ensure consistent handling of text.

The term “segmentation” refers to a process of dividing document data into units such as tokens, words, sentences, or other linguistic units used for subsequent analysis.

The term “structured data” refers to data that has been organized according to a defined schema or format, including explicit annotations such as word-level and sentence-level structure information, part-of-speech information, and semantic unit information.

The term “linguistic annotations” refers to additional information attached to text elements, such as part-of-speech tags, syntactic relationships, or semantic roles, that describe linguistic properties of the text.

The term “topic classification information” refers to data indicating one or more categories or subject domains to which document data belongs, determined by analysis of the content of the document data.

The term “feature term information” refers to data indicating one or more terms, phrases, or expressions that are identified as characteristic or representative of the content of document data.

The term “emotional state information” refers to data representing an inferred affective state, such as positive, negative, or neutral sentiment, associated with the content of document data.

The term “stance information” refers to data representing an inferred attitude or position, such as support, opposition, or neutrality, expressed or implied in the content of document data with respect to a particular subject.

The term “cross-document similarity information” refers to data indicating a degree of similarity or relatedness between one piece of document data and one or more other pieces of document data based on content or semantics.

The term “feature set” refers to a collection of one or more feature values derived from document data and associated metadata, used as input to a machine learning model.

The term “source history information” refers to feature data that describes past behavior or characteristics of an information source, including but not limited to previous reliability evaluations and frequency of updates.

The term “similarity information” refers to feature data indicating how similar a given document is to other documents in terms of content, semantics, or structure.

The term “update history information” refers to feature data indicating how often and when particular document data or associated information sources have been updated.

The term “content consistency information” refers to feature data indicating a degree of consistency or inconsistency between content of one document and content of other documents regarded as reference or baseline content.

The term “user feedback information” refers to data received from a user or a user terminal that indicates an evaluation, opinion, or reaction to particular document data or reliability assessments.

The term “deep learning model” refers to a machine learning model composed of multiple layers of computational units, such as neural network layers, trained on data to approximate a function for tasks including classification or regression.

The term “trained deep learning model” refers to a deep learning model whose parameters have been optimized using training data such that the model can compute reliability indices or other outputs from feature sets.

The term “reliability index” refers to a numerical or categorical value computed by the deep learning model that indicates an estimated degree of trustworthiness or accuracy of document data.

The term “reliability classification information” refers to data indicating a classification category, such as high, medium, or low, derived from the reliability index for document data.

The term “cross-reference information” refers to data indicating whether and how a claim or content in one document is supported, contradicted, or unreported by other documents or information sources.

The term “explanation tag information” refers to structured labels or indicators associated with document data that describe reasons or factors underlying a reliability index or classification, including cross-reference information and source-related features.

The term “generative AI model” refers to a machine learning model capable of generating text or other content in response to input data or prompt sentences, including models based on neural networks.

The term “prompt sentence” refers to text or structured input data generated by the processor and provided to the generative AI model to specify a task or context for generating summary information or explanation information.

The term “summary information” refers to generated text that concisely represents main points or essential content of document data.

The term “explanation information” refers to generated text that describes reasons, context, or justification for a reliability index or classification assigned to document data.

The term “generative output” refers to any text or data produced by the generative AI model in response to a prompt sentence, including summary information and explanation information.

The term “evaluation target document data” refers to document data selected by the processor, based on one or more criteria such as reliability index and topic classification, for provision to a user terminal.

The term “user terminal” refers to an electronic device operated by a user, such as a client computer or mobile device, that communicates with the server via the communication network to receive response data and transmit feedback.

The term “user attribute information” refers to data indicating characteristics related to a user, including but not limited to preferences, usage history, and language settings, used for personalizing response data.

The term “user selection conditions” refers to conditions specified by a user, such as desired topics, minimum reliability thresholds, or content types, used to filter or rank evaluation target document data.

The term “response data” refers to data generated by the processor that includes at least selected document data, associated reliability indices, and associated generative output, and that is transmitted to a user terminal.

The term “evaluation feedback information” refers to data transmitted from a user terminal to the server that indicates the user's evaluation or reaction regarding particular document data, reliability assessments, or generative output.

The term “structured prompt sentence” refers to a prompt sentence that is generated in a predefined structured format, including multiple fields such as topic classification information, feature term information, reliability index, and explanation tag information, to guide the generative AI model.

The term “training data” refers to data, including feature sets and associated target values or labels such as user feedback or ground-truth reliability information, used to adjust parameters of the deep learning model or other models.

The term “process for generating the structured prompt sentence” refers to a sequence of operations executed by the processor to construct structured prompt sentences from document data, feature sets, and reliability-related information.

In one embodiment, a server executes a set of software modules implementing the claimed system on a hardware platform including at least one central processing unit (CPU), an optional graphics processing unit (GPU), a main memory, a non-volatile storage device, and a network interface. The server runs an operating system such as a general-purpose server operating system, and executes application programs written, for example, in a high-level programming language such as Python. The server optionally uses software libraries including a web crawling framework (for example, a generic web crawling framework comparable to Scrapy), an HTTP client library (for example, a generic request library), an HTML parser (for example, a generic DOM parsing library comparable to BeautifulSoup), a natural language processing toolkit (for example, a toolkit comparable to spaCy or NLTK), and a deep learning framework (for example, a framework comparable to PyTorch or TensorFlow). The server stores document data, metadata, and model parameters in a database management system such as a relational database or a document-oriented database.

The server acquires document data and metadata from multiple information sources via a communication network. The server uses the network interface to transmit HTTP or HTTPS requests to content distribution services, social communication services, and other information sources. The server receives electronic responses containing text content and associated metadata such as publication time and source identifiers. The server assigns acquisition time information and source identification information to each unit of document data and writes the combined data into structured records in a storage device. By assigning such information at acquisition time, the server enables later modules to track source behavior and temporal patterns, which improves the reliability estimation accuracy and avoids redundant retrieval, thereby reducing network load.

The server performs preprocessing on the stored document data to convert unstructured text into structured data suitable for machine processing. The server executes character code normalization to unify encodings such as different Unicode normalization forms into a canonical representation, removes unnecessary symbols such as HTML tags and markup, and segments the text into tokens and sentences using predefined tokenization rules. The server further generates linguistic annotations including part-of-speech tags, dependency relations, and semantic unit boundaries using models provided by the natural language processing toolkit. The server stores the structured data in a schema that, for each document, includes a list of tokens, sentence indices, part-of-speech tags, dependency arcs, and semantic units as separate fields. This explicit structure allows the server to reuse parsed representations across multiple downstream tasks, thereby reducing repeated parsing and lowering the overall CPU usage compared with systems that perform ad-hoc parsing per task.

The server derives topic classification information and feature term information from the structured data using both statistical and machine learning methods. The server constructs term frequency vectors per document and computes term importance scores such as term frequency-inverse document frequency values. The server uses these scores, in combination with attention weights from a text encoder implemented in the deep learning framework, to identify feature term information that characterizes the content of each document. The server applies a topic classifier, for example a neural network whose input layer receives pooled text embeddings and whose output layer produces probabilities over predefined categories such as politics, economics, society, and technology. The server assigns to each document a topic classification label and a confidence value. By encoding topic and feature terms as structured attributes, the server allows subsequent models to incorporate high-level semantic categories without reprocessing the raw text, which improves inference speed and reduces memory footprint.

The server also derives emotional state information and stance information from content originating from social communication services and opinion-bearing sources. The server feeds sequences of token embeddings into a sentiment classifier implemented as a neural network that may include an embedding layer, one or more recurrent or transformer layers, and a classification head. The server obtains probability distributions over sentiment categories (for example, positive, negative, neutral) and maps these to emotional states such as joy, anger, or concern. The server further uses a stance detection model that receives the text and a representation of a target issue as inputs and outputs probabilities for support, opposition, or neutrality. The server stores the emotional state information and stance information as part of the structured representation. These attributes form part of the feature set used for reliability evaluation; by encoding them numerically and storing them centrally, the server reduces the need to repeatedly run sentiment analysis for different reliability models, thus reducing computation time.

The server constructs a feature set for each document from multiple sources of information. The server computes source history information by aggregating past reliability indices and misclassification statistics for each source identification information. The server computes similarity information by embedding documents into a vector space using a text encoder, such as a transformer-based encoder, and then performing nearest-neighbor or clustering operations to detect groups of semantically similar documents. The server calculates cross-document similarity scores and identifies clusters of documents that share claims or events. The server derives update history information from acquisition time information and from timestamps present in metadata, capturing how frequently a source or a topic is updated. The server computes content consistency information by comparing the claims of a document, extracted via dependency parses and named entity recognition, with those of other documents in the same similarity cluster, and determining whether the claims are corroborated or contradicted.

The server combines these values into a numerical feature vector for each document and stores the vectors in a feature table.

The server applies a trained deep learning model to the feature sets to compute a reliability index for each document. In one implementation, the server uses a multi-layer neural network whose input layer receives the concatenated feature vector, whose hidden layers consist of fully connected layers with non-linear activation functions, and whose output layer produces a continuous value between 0 and 1 representing the reliability index. During training, the server uses labeled data including historical judgments about document reliability and user feedback information. The server defines a loss function, such as mean squared error for regression or cross-entropy for classification, and updates model weights using gradient-based optimization methods such as stochastic gradient descent or adaptive moment estimation. The server performs regularization, such as dropout or weight decay, to prevent overfitting. The server stores the trained model parameters in persistent storage and loads them into memory during inference. By training this model on feature sets that explicitly encode cross-source similarity and user feedback, the server improves predictive accuracy and generalization compared with models that rely only on local document features.

The server assigns reliability classification information and explanation tag information to each document based on the computed reliability index and intermediate analysis results. The server maps the reliability index to classes such as “high,” “medium,” or “low” according to configurable thresholds. The server generates explanation tag information, such as “supported by multiple independent sources,” “originated from low-reputation source,” or “contradicts official records,” using rule-based logic that inspects source history information, content consistency information, and cross-reference information. These explanation tags create a compact, machine-readable rationale that can be reused when constructing explanation-oriented prompts, reducing the amount of raw data that must be encoded and transmitted to subsequent modules.

The server constructs a prompt sentence for a generative AI model for each document. The server assembles structured prompt sentences that explicitly include the topic classification information, feature term information, reliability index, cross-reference information, and explanation tag information. The prompt sentence may assume a format such as:
“Summarize the following news article and explain, in plain language, why the reliability score is 0.91. Topic: economics. Key terms: market growth, interest rate policy, trade agreement. Explanation tags: supported by multiple trusted_sources, consistent_with_official_statistics. Article: [article text]”

The server may use other prompt sentence examples, such as:
“Analyze these social media posts about climate policy. Using the following metadata (topic: environment; key terms: emissions reduction, carbon tax; explanation tags: mixed_sentiment, conflicting_sources), generate a concise summary of public reactions and explain why the system has assigned a medium reliability score.”
“From the following blog posts about a new medical technology, identify expert opinions and distinguish them from general user comments, given that key terms are: clinical trial, side effects, approval process, and explanation tags include: limited_number_of_sources, early_stage_information.”
“Given this article with reliability score 0.32 and explanation tags: low_reputation_source, conflicts_with_official_data, generate a warning message suitable for end users that briefly explains the reasons for the low reliability.”

The server transmits each prompt sentence to a generative AI model via an application programming interface or via a local inference service. The generative AI model may be implemented as a large neural network, such as a transformer-based language model composed of an embedding layer, a plurality of self-attention blocks, and an output projection layer. The server encodes the prompt sentence into tokens and sends them as input to the model. The model processes the tokens through its layers, computing attention scores and contextual representations, and outputs probability distributions over possible next tokens.

The server samples or decodes the output sequences using strategies such as greedy decoding or beam search to obtain summary information and explanation information. The server then associates this generative output with the corresponding document record in storage.

The server validates the generative output to prevent propagation of inconsistent or obviously erroneous explanations. The server cross-checks key numeric values and named entities mentioned in the generated explanation information against stored metadata and trusted references; if the generated output conflicts with stored values beyond permitted thresholds, the server may discard or regenerate the output with a modified prompt sentence that emphasizes factual constraints. This validation reduces the risk of incorrect AI-generated explanations and avoids unnecessary retransmissions to user terminals, thereby lowering communication overhead.

The server generates response data for user terminals by selecting evaluation target document data according to user attribute information and user selection conditions. The server maintains user profiles that store preferences such as interested topics, preferred languages, and minimal acceptable reliability levels. The server executes a selection algorithm that filters documents based on topic classification and reliability index, and ranks them according to a composite score combining recency, reliability, and user interest. The server packages, for each selected document, the title, a snippet of text, the reliability index, the reliability classification information, and the associated summary information and explanation information into a response structure. The server transmits this response data over the communication network to one or more user terminals. By performing selection and aggregation on the server side, the system reduces the amount of data transmitted and the processing burden on user terminals, which is particularly beneficial in bandwidth-limited environments.

The terminal operates as a client device, such as a smartphone, tablet, or personal computer, equipped with a display, an input interface, and a communication interface. The terminal executes a client application, for example implemented as a native mobile application or a web application running in a browser. The terminal sends requests to the server that include current user selection conditions such as “economics topic only,” “reliability index at least 0.8,” or “include social communication posts.” The terminal receives the server's response data and parses the structured fields using a local parsing library.

The terminal displays the selected documents using the display device. The terminal renders titles, summary information generated by the generative AI model, and reliability indicators derived from the reliability index. The terminal may color-code high-reliability documents and show warning icons for low-reliability documents. The terminal provides interactive elements allowing the user to expand explanation information, which contains natural-language reasoning produced by the generative AI model based on explanation tag information and cross-reference information. The terminal thereby enables the user to understand not only the content but also the reasons why the system has assigned particular reliability indices.

The user interacts with the terminal using input devices such as a touchscreen, keyboard, or pointing device. The user selects items of interest, adjusts filters (for example, excluding sources with low historical reliability), and submits evaluation feedback information through user interface elements such as buttons labeled “Seems incorrect,” “Reliable,” or “Not relevant.” The terminal packages user feedback together with document identifiers and sends this information to the server via the communication network.

The server receives evaluation feedback information from multiple terminals and integrates it into the reliability evaluation pipeline. The server stores feedback records associated with document identifiers and user identifiers. The server periodically aggregates feedback to generate derived labels, such as an average user-perceived reliability score for each document or source. The server incorporates this user feedback information into the feature sets used by the deep learning model, for example by including statistics of positive and negative feedback as additional feature dimensions. The server retrains or fine-tunes the deep learning model using updated training data that combines historical labels, cross-source features, and user feedback features. During retraining, the server continues to use defined loss functions and optimization algorithms, and adjusts hyperparameters such as learning rate or batch size to maintain stability. The server can also update the process for generating structured prompt sentences by modifying which explanation tags are included or how they are phrased, based on observed mismatches between user feedback and explanation information. Through this closed feedback loop, the server improves the alignment between computed reliability indices and user expectations, while maintaining efficient model performance.

In additional embodiments, the server may employ alternative deep learning architectures, such as graph neural networks that explicitly model relationships among documents and sources as nodes and edges in a graph structure. In such cases, the server computes node features based on document-level and source-level attributes, and edge features based on cross-document similarity and temporal relationships. The server trains the graph neural network using supervised or semi-supervised methods to predict reliability indices for nodes corresponding to documents. This architecture can improve the ability of the system to propagate reliability information along the network of related documents, thereby increasing robustness against localized misinformation.

The server may also implement alternative generative AI models, such as encoder-decoder architectures or smaller domain-specific language models, depending on resource constraints.

The server can dynamically choose between a large cloud-hosted generative AI model and a smaller on-premise model based on current network conditions and latency requirements. By encoding prompt sentences in a structured and compressed form, the server reduces the number of tokens that must be processed by the generative AI model, leading to lower computation times and reduced network traffic for remote inference.

By integrating acquisition, preprocessing, feature construction, deep learning-based reliability evaluation, structured prompt sentence generation, generative explanation, and user feedback incorporation in a unified architecture, the server achieves technical improvements over conventional systems. The server avoids repeated parsing and redundant similarity computations by storing reusable structured data and similarity features, which reduces CPU cycles and memory access. The reliance on explicit feature sets that encode cross-source and temporal relationships enables the deep learning model to achieve higher accuracy in reliability estimation with fewer parameters than models that rely solely on raw text, which improves inference speed and energy efficiency. The structured prompt sentences allow the generative AI model to focus on relevant context and explanation tags, reducing unnecessary exploration of the token space and thereby lowering computational cost and latency.

Furthermore, the system does not merely automate a human cognitive task; instead, the server configures the computational processing pipeline to use data structures and model interactions that are not feasible in manual workflows. The server continuously refines its models using machine-readable user feedback and cross-document graph structures, and exposes this refined knowledge through structured prompts that control the generative AI model. This configuration yields measurable improvements in processing speed, reliability estimation accuracy, communication efficiency, and consistency of explanations, demonstrating that the claimed system constitutes a specific improvement in computer technology rather than an abstract automation of human reasoning.

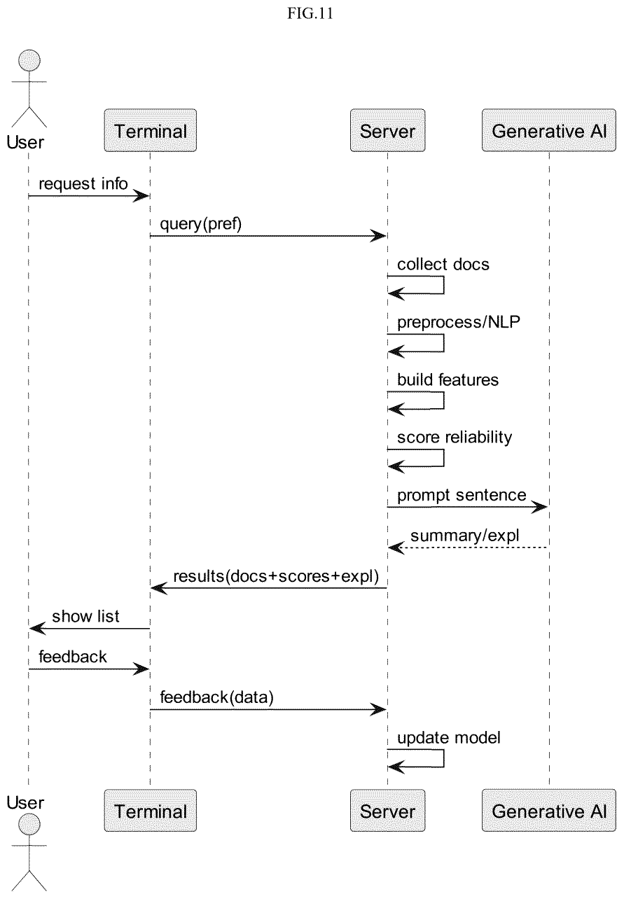

The following describes the processing flow using FIG. 11.

### Step 1:

The server receives configuration data as input, including a list of information sources, access credentials, crawl intervals, and content categories. The server uses this configuration to generate and schedule network requests to multiple information sources via a communication network. The server transmits HTTP or HTTPS requests and receives responses containing document data and metadata such as original timestamps and source identifiers. The server performs data parsing on the responses, extracting text bodies, titles, and metadata fields, and writes structured records into a storage device. The output of Step 1 is a set of stored document records, each associated with acquisition time information and source identification information.

### Step 2:

The server reads, as input, the stored document records generated in Step 1. The server performs preprocessing operations on the raw text contained in the document data, including character code normalization, removal of markup symbols, and segmentation of the text into tokens and sentences. The server then executes natural language processing operations, assigning part-of-speech tags, syntactic dependencies, and semantic unit boundaries to the tokens. The server stores these annotations in a structured data format, such as token lists, sentence indices, and tag sequences linked to each document. The output of Step 2 is a collection of structured document representations that include both the original text and associated linguistic annotations.

### Step 3:

The server takes, as input, the structured document representations produced in Step 2. The server computes statistical features such as term frequencies and document frequencies, and applies a topic classification model to derive topic classification information for each document. The server identifies feature term information by selecting terms or phrases with high importance scores, combining statistical measures and attention scores from a text encoder. The server writes the topic labels and feature term lists into the structured records for each document. The output of Step 3 is an enhanced set of document records that include topic classification information and feature term information in addition to the linguistic annotations.

### Step 4:

The server receives, as input, the enhanced document records from Step 3, focusing on records derived from social communication services and opinion-bearing sources. The server encodes the token sequences using a text embedding layer and feeds the embeddings into a sentiment classification network to compute probability distributions over sentiment categories. The server maps these probabilities to emotional state information such as positive, negative, or neutral, and to more fine-grained emotional descriptors. The server optionally applies a stance detection network that evaluates the document content in relation to a given target issue and outputs stance information such as support, opposition, or neutrality. The server appends emotional state information and stance information to each relevant document record. The output of Step 4 is a set of document records that include topic labels, feature terms, emotional states, and stances.

### Step 5:

The server uses, as input, the annotated document records from Step 4 and historical source information stored in the database. The server aggregates past reliability indices and update histories for each source identification information to generate source history information.

The server encodes each document into a vector representation using a text encoder and computes cross-document similarity scores by comparing vector representations. The server forms clusters of related documents and derives cross-document similarity information and content consistency information by comparing claims within each cluster. The server also derives update history information from acquisition time information and metadata timestamps. The server constructs a numerical feature vector for each document that includes source history information, similarity information, update history information, content consistency information, and, optionally, user feedback information. The output of Step 5 is a feature set table, where each document is associated with a feature vector.

### Step 6:

The server loads, as input, the feature vectors generated in Step 5 and the parameters of a trained deep learning model stored in persistent memory. The server feeds batches of feature vectors into the deep learning model, which performs a sequence of matrix multiplications, non-linear activations, and normalization operations through multiple layers. The deep learning model outputs reliability indices for each document, represented as continuous values, and may also output intermediate scores corresponding to component features. The server converts the reliability indices into reliability classification information by applying predefined thresholds, and generates explanation tag information by evaluating rule-based conditions on source history, content consistency, and cross-reference attributes. The server stores the reliability indices, reliability classes, and explanation tags into the document records. The output of Step 6 is a set of evaluated document records, each with a reliability index, a reliability class, and explanation tag information.

### Step 7:

The server takes, as input, the evaluated document records from Step 6. The server constructs, for each document, a prompt sentence for a generative AI model by concatenating or formatting fields including topic classification information, feature term information, reliability index, explanation tag information, and, optionally, relevant portions of the original text. The server performs string assembly and, where necessary, truncation or compression of text segments to meet input size constraints of the generative AI model. The server sends the resulting prompt sentence over an application programming interface or local inference interface to the generative AI model. The output of Step 7 is a sequence of prompt sentences submitted to the generative AI model, each linked to a specific document record.

### Step 8:

The server receives, as input, output token sequences from the generative AI model in response to the prompt sentences generated in Step 7. The server decodes these tokens into text, splitting the text into summary information and explanation information according to predefined markers or sections in the prompt. The server checks the generated text against stored metadata and trusted references, verifying that key numerical values and named entities do not conflict with known values beyond configured thresholds. The server discards or regenerates generative outputs that fail validation, and accepts generative outputs that pass validation. The server associates the accepted summary information and explanation information with the corresponding document records in the database. The output of Step 8 is a set of document records augmented with validated generative output.

### Step 9:

The server reads, as input, user attribute information and user selection conditions received from one or more terminals. The server also reads the evaluated and augmented document records produced in Step 8. The server filters documents based on topic classification information, reliability index thresholds, and other user selection conditions such as content type or time range. The server computes a ranking score for each candidate document, combining factors such as recency, reliability index, and match to user preferences. The server selects the top-ranked documents as evaluation target document data and constructs response data structures that include, for each selected document, its title, a snippet of the original text, the reliability index, the reliability class, the summary information, and the explanation information. The server transmits the response data over the communication network to the requesting terminals. The output of Step 9 is a set of response data payloads delivered to terminals.

### Step 10:

The terminal receives, as input, the response data from the server generated in Step 9. The terminal parses the response structures to extract document fields such as titles, summaries, reliability indices, and explanation texts. The terminal generates user interface elements, such as lists or cards, for each document, and maps the reliability indices to visual indicators such as colors or icons. The terminal renders the interface on a display, showing the user a filtered and ranked list of evaluation target document data with associated generative explanations.

The output of Step 10 is a graphical presentation on the terminal that allows the user to view summarized content and understand reliability assessments.

### Step 11:

The user observes, as input, the displayed documents and associated reliability indicators and explanations on the terminal. The user performs interactive operations such as tapping on a document card, expanding detailed explanations, or using filters to adjust topic or reliability thresholds. The user evaluates the correctness or usefulness of the presented information and may provide evaluation feedback by selecting interface elements such as “Incorrect,” “Reliable,” or “Not helpful.” The user's actions generate feedback signals that the terminal converts into structured evaluation feedback information linked to document identifiers. The output of Step 11 is a set of user feedback commands ready to be transmitted to the server.

### Step 12:

The terminal receives, as input, the user's interaction events and feedback selections from Step 11. The terminal packages these events into structured evaluation feedback information, including document identifiers, user identifiers or session identifiers, and feedback labels or scores. The terminal transmits the evaluation feedback information to the server via the communication network. The output of Step 12 is a set of feedback messages delivered to the server.

### Step 13:

The server accepts, as input, the evaluation feedback information from multiple terminals produced in Step 12. The server stores each feedback record in association with the corresponding document data and user data. The server periodically aggregates feedback statistics, computing metrics such as the proportion of positive and negative feedback per document and per source. The server updates the feature sets generated in Step 5 by appending feedback-based features, such as counts or normalized scores, to the feature vectors. The server then uses the updated feature vectors as input for retraining or fine-tuning the deep learning model, adjusting model weights by minimizing an error function defined over both historical labels and new feedback-derived labels. The output of Step 13 is an updated deep learning model and an updated process for generating prompt sentences that incorporate the latest user feedback and cross-document behavior.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional security information systems that collect data from networked sources and perform rule-based or static machine-learning analysis suffer from several technical limitations at the computer-system level. First, such systems typically process heterogeneous text data and communication log data in separate pipelines, resulting in fragmented feature representations in memory structures and inefficient use of processor and storage resources. This separation often prevents the system from accurately correlating semantic threat information contained in unstructured text with statistical anomalies detected in time-series communication logs, which degrades the precision and recall of automated threat detection.

Second, conventional reliability evaluation mechanisms often rely on simple heuristic scoring or shallow models that do not fully exploit historical correlations between threat instances, incident occurrences, and the effectiveness of previously executed countermeasures. As a result, processor cycles and memory bandwidth are consumed by evaluating and alerting on large numbers of low-value or false-positive events, thereby overwhelming communication channels and user interfaces and hindering timely processing of truly critical threats. From a computer-technology standpoint, this leads to sub-optimal allocation of computation, storage, and network resources across a distributed security infrastructure.

Third, known systems typically provide limited or static countermeasure selection capabilities. They often map detected threats to predefined, coarse-grained actions without dynamically tailoring configuration change commands or control requests to the specific environment state and current threat context. This lack of adaptability forces administrators to manually reconcile high-level recommendations with low-level device configurations.

Consequently, network devices, monitoring devices, and configuration management devices are not controlled in a coordinated and optimized manner, resulting in increased latency and error risk in the application of security settings, communication blocking, and update program deployment.

Fourth, many systems are unable to leverage advanced generative artificial intelligence models in a structured and safe way. Without a defined mechanism for constructing and managing prompt sentences based on internal feature information and reliability scores, calls to generative models are ad hoc, non-deterministic, and difficult to reproduce. This undermines the ability of the processor to consistently transform model outputs into machine-executable configuration change commands and user-oriented explanations, and complicates logging and auditing of decisions for later analysis and model improvement.

Fifth, user-facing interfaces in existing solutions often present highly technical alerts directly to non-expert users. This causes cognitive overload and improper user responses, and forces front-end applications on terminals to perform additional processing to reformat or simplify notifications. Such post-processing increases computational load on client devices and introduces inconsistencies between back-end threat evaluation and front-end messaging.

There is therefore a need for a server-side mechanism that programmatically generates both technical explanations and simplified, non-expert-oriented explanations in a coordinated manner, while maintaining a clear binding to the underlying feature information and reliability scores stored in system memory.

Accordingly, there is a need for an improved computer-implemented security information processing system and server that: (i) unifies collection and processing of text data and communication log data into coherent feature information, (ii) employs deep learning-based reliability evaluation tightly integrated with historical threat and countermeasure records, (iii) systematically utilizes generative artificial intelligence models via structured prompt sentences to generate context-specific countermeasure candidates and explanations, and (iv) automatically converts such outputs into coordinated configuration change commands and control requests for multiple system elements, while generating consistent technical and non-expert-oriented outputs. Such a system should improve the efficiency, accuracy, and robustness of computer-implemented threat detection, reliability evaluation, and automated response at the infrastructure level.

The specific processing by the specific processing unit 290 of the data processing device 12 in Application Example 1 is realized by the following means.

The present invention provides a server comprising a processor, a memory, and a communication interface, wherein the processor is configured to function as an information collection unit that, via the communication interface, acquires text data from a plurality of external information sources and communication log data from a plurality of system elements and stores the acquired data as structured records in the memory, as an analysis unit that performs natural language processing and statistical processing on the text data and the communication log data to generate feature information indicating at least threat types, attack methods, related resources, and abnormal communication patterns, as a reliability evaluation unit that inputs the feature information into one or more machine-learning algorithms and deep-learning algorithms trained on historical threat instances, incident occurrences, and countermeasure results and that calculates, for each detected threat instance, a reliability score and a priority level based on multiple factors including at least a type of information source, a consistency of content, past reliability evaluations, an information update frequency, and a degree of anomaly in associated communication data, as a countermeasure generation unit that, for a threat instance whose priority level satisfies a predetermined condition, assembles a prompt sentence including the feature information, the reliability score, and the priority level into a structured input for a generative AI model, transmits the prompt sentence to the generative AI model, acquires countermeasure candidates, recommended priorities, and explanatory information from the generative AI model, and converts the countermeasure candidates into configuration change commands or control requests for network devices, monitoring devices, and configuration management devices, as a countermeasure execution unit that applies the configuration change commands or the control requests to the system elements via the communication interface so as to automatically execute security setting changes, communication path blocking, and update program application and to store execution results in the memory, and as an information provision unit that generates technical explanation outputs and non-expert user-oriented outputs based on the reliability score, the priority level, the feature information, and the explanatory information, uses a prompt sentence to cause the generative AI model to generate simplified explanations for non-expert users, and provides the technical explanation outputs and the non-expert user-oriented outputs through one or more user interfaces. This enables integration of heterogeneous security data streams into unified feature information, efficient and accurate deep learning-based reliability evaluation, reproducible and structured interaction with generative AI models via prompt sentences, automatic translation of model outputs into coordinated low-level configuration changes across multiple system elements, and consistent delivery of both technical and simplified explanations, thereby improving the overall performance, scalability, and robustness of computer-implemented security monitoring and automated response.

The term “processor” refers to one or more hardware processing units, such as a central processing unit or a graphics processing unit, configured to execute instructions stored in a memory so as to implement one or more functional units of the system.

The term “memory” refers to one or more non-transitory computer-readable storage media, such as semiconductor memory devices, magnetic storage devices, or optical storage devices, configured to store instructions and data used by the processor.

The term “communication interface” refers to a hardware and software subsystem that enables the server to transmit and receive data over one or more communication networks using wired or wireless communication protocols.

The term “information collection unit” refers to a functional unit implemented by the processor that acquires data from external information sources and internal system elements via the communication interface and stores the acquired data in the memory as structured records.

The term “analysis unit” refers to a functional unit implemented by the processor that performs natural language processing and statistical processing on text data and communication log data to generate feature information relating to security threats.

The term “reliability evaluation unit” refers to a functional unit implemented by the processor that uses one or more machine-learning algorithms and deep-learning algorithms to calculate, for each detected threat instance, a reliability score and a priority level based on feature information and historical data.

The term “countermeasure generation unit” refers to a functional unit implemented by the processor that constructs prompt sentences including feature information and evaluation results, transmits the prompt sentences to a generative AI model, receives countermeasure candidates and explanatory information, and converts them into configuration change commands or control requests.

The term “countermeasure execution unit” refers to a functional unit implemented by the processor that applies configuration change commands or control requests to system elements via the communication interface to automatically perform security setting changes, communication path blocking, and update program application.

The term “information provision unit” refers to a functional unit implemented by the processor that generates technical explanation outputs and non-expert user-oriented outputs based on internal evaluation results and explanatory information, optionally using a generative AI model, and provides the outputs through one or more user interfaces.

The term “external information source” refers to an information-providing system accessible over a communication network, such as a news distribution service, a social information sharing service, an electronic bulletin service, or a record publication service, from which text data can be acquired.

The term “system element” refers to an individual component of an information system, including but not limited to a network device, a monitoring device, a configuration management device, or an information processing device that generates or receives security-related data.

The term “text data” refers to data represented primarily in a character-based format, such as articles, posts, messages, or reports obtained from external information sources, which may include metadata such as time information and source type information.

The term “communication log data” refers to data representing records of communication activities, such as connection records, packet statistics, or event logs, generated by communication control devices or monitoring devices and collected for analysis.

The term “structured record” refers to a data structure stored in the memory that organizes acquired data into predefined fields, such as time information, source type information, and collection batch information, enabling efficient retrieval and processing.

The term “time-series database” refers to a data storage subsystem optimized for storing and querying data records indexed by time, used to store and retrieve communication log data with associated timestamps.

The term “natural language processing” refers to a set of computational techniques that operate on human-readable text, including at least tokenization, part-of-speech tagging, syntactic analysis, and phrase extraction, to derive structured features.

The term “statistical processing” refers to computations performed on communication log data to obtain aggregated values and metrics, including at least time-window aggregation and anomaly detection based on statistical models or thresholds.

The term “feature information” refers to structured data derived from text data and communication log data that represents characteristics of potential threats, including at least threat types, attack methods, related resources, and abnormal communication patterns.

The term “threat instance” refers to a unit of analysis corresponding to a particular potential or detected security threat, defined by associated feature information, source data, and evaluation results.

The term “reliability score” refers to a numerical value calculated by the reliability evaluation unit that indicates a probability or degree that a threat instance corresponds to an actual or meaningful security threat.

The term “priority level” refers to a classification assigned to a threat instance, derived from the reliability score and other factors, that indicates a relative urgency or importance for responding to the threat instance.

The term “information source type” refers to a classification of an origin of data, such as a type of external information source or an internal device category, used as a factor in the reliability evaluation.

The term “consistency of content” refers to a degree of agreement or alignment between data describing a threat instance across multiple sources or records, used as an input to the reliability evaluation.

The term “information update frequency” refers to a rate or pattern at which information related to a threat instance or an information source is updated or refreshed over time, used as a factor in the reliability evaluation.

The term “degree of anomaly” refers to a quantitative or qualitative measure of deviation of communication data from expected or baseline behavior, derived from statistical processing and used in the reliability evaluation.

The term “machine-learning algorithm” refers to a computational model that learns a mapping from input data to output values or labels based on training data, including but not limited to classification or regression models.

The term “deep-learning algorithm” refers to a machine-learning algorithm that employs a multi-layer neural network architecture to learn representations of input data and to output evaluation results such as reliability scores and priority levels.

The term “historical data” refers to stored records of past threat instances, incident occurrences, and countermeasure results, which are used to train or update machine-learning algorithms and deep-learning algorithms.

The term “generative AI model” refers to a machine-learning model, such as a large language model or other generative model, configured to produce text or structured output in response to input data and prompt sentences.

The term “prompt sentence” refers to a formatted input text or sequence of tokens provided to a generative AI model, constructed to specify a task, constraints, or context, and including at least feature information and evaluation results.

The term “countermeasure candidate” refers to a proposed action or set of actions, generated automatically or by the generative AI model, that is intended to mitigate or prevent a security threat represented by a threat instance.

The term “configuration change command” refers to an instruction or set of instructions suitable for application to a system element, such as a network device or configuration management device, to modify its operational parameters or security settings.

The term “control request” refers to a communication sent to a system element instructing the system element to perform a particular operation, such as blocking communication, applying an update program, or changing a monitoring mode.

The term “network device” refers to a hardware or software component that controls or routes communication traffic in a network, such as a router, firewall, gateway, or switch.

The term “monitoring device” refers to a hardware or software component that observes and records communication activities or system events, such as an intrusion detection system, a log collection system, or a performance monitor.

The term “configuration management device” refers to a system or tool that deploys, modifies, or manages configurations or software on one or more information processing devices, including automated deployment or orchestration tools.

The term “security setting change” refers to a modification of configuration parameters related to protection of information or communication, such as access control rules, encryption settings, or authentication requirements.

The term “communication path blocking” refers to an operation that prevents or restricts data traffic along one or more network paths, such as by dropping packets, filtering connections, or modifying routing rules.

The term “update program application” refers to an operation that installs or activates updated software, patches, or configuration sets on system elements to remediate vulnerabilities or improve security.

The term “execution result” refers to data indicating a status or outcome of an applied configuration change command or control request, such as success, failure, or partial completion, optionally with associated diagnostic information.

The term “technical explanation output” refers to information presented in a form intended for users with technical knowledge, including detailed descriptions of threat instances, feature information, evaluation results, and applied countermeasures.

The term “non-expert user-oriented output” refers to information presented in a simplified and non-technical form suitable for users without specialized security expertise, including clear instructions on required user actions.

The term “user interface” refers to a software or hardware mechanism through which information is presented to a user and through which the user may provide input, including graphical user interfaces, command-line interfaces, and application programming interfaces.

The term “automatic acquisition process” refers to a program or set of program instructions executed by the processor to periodically obtain data from external information sources or system elements without manual user intervention.

The term “collection batch information” refers to data that associates acquired records with a particular execution of the automatic acquisition process, enabling grouping and reference by acquisition time or cycle.

The term “structured input format” refers to an arrangement of data elements, such as fields in a serialized object or entries in a markup language, used to encode feature information and evaluation results as an input to a generative AI model.

The term “recommended priority” refers to a suggestion produced by a generative AI model regarding an order or urgency of executing one or more countermeasure candidates.

The term “explanatory information” refers to text or structured data that explains, justifies, or contextualizes countermeasure candidates, evaluation results, or threat instances for use in technical or non-expert outputs.

The term “simplified explanation” refers to a form of explanatory information generated specifically to reduce technical complexity and to improve comprehensibility for non-expert users while preserving key risk and action information.

In one embodiment, a server, a plurality of terminals, and a communication network constitute a security information processing system. The server includes at least one processor, a main memory, a non-volatile storage device, and a communication interface. The processor executes software modules stored in the non-volatile storage device and loaded into the main memory, thereby implementing an information collection unit, an analysis unit, a reliability evaluation unit, a countermeasure generation unit, a countermeasure execution unit, and an information provision unit. The terminals each include a processor, a memory, a user interface, and a communication interface, and communicate with the server over the communication network.

The server uses general-purpose hardware such as a multi-core central processing unit and, in some embodiments, a graphics processing unit or tensor processing unit for accelerating deep-learning computations. The server uses an operating system such as a general-purpose server operating system, and middleware such as a relational database management system, a time-series database, and a message queue system. In one example, the server uses an SQL-based database to store structured records of text data, and a time-series-optimized database to store communication log data indexed by timestamps.

The server implements the information collection unit in software that executes on the processor. The server uses network libraries and an HTTP client to access external information sources, including news distribution services, social information sharing services, electronic bulletin services, and record publication services. The server acquires text data via HTTP or HTTPS and normalizes the data into a unified character encoding, such as UTF-8. The server also acquires communication log data from network devices and monitoring devices via syslog, simple network management protocol, or a representational state transfer interface and stores the log data in the time-series database.

The server stores the acquired data as structured records. For text data, the server creates records with fields including a document identifier, a source type, a collection time, a title, a body, and collection batch information. For communication log data, the server creates records with fields including a log identifier, a source device identifier, a timestamp, a source address, a destination address, a protocol, a port number, a byte count, and a flag indicating a detection event if present. By storing both text data and communication log data in structured records with explicit keys, the server enables subsequent processing modules to access and correlate related information efficiently using indexed queries. This data structuring improves cache utilization and reduces input/output overhead in comparison with conventional systems that store data as unstructured text blobs.

The server implements the analysis unit as a software module that performs natural language processing on text data and statistical processing on communication log data. For natural language processing, the server uses a tokenizer, a part-of-speech tagger, a syntactic parser, and a phrase extractor. In one embodiment, the server uses a transformer-based language representation model with multiple self-attention layers to compute contextual embeddings for each token in a document. The server converts each document into a fixed-length feature vector by pooling token embeddings, and additionally extracts named entities and security-related phrases such as “phishing attack,” “ransomware,” and “distributed denial-of-service attack.” For communication log data, the server aggregates records into time windows, such as one-minute or five-minute intervals, and computes statistical features including average packet rate, maximum burst rate, distribution of ports, and entropy of destination addresses. The server applies anomaly detection algorithms such as isolation forest or autoencoder-based outlier detection to detect abnormal communication patterns.

The server combines features from text data and communication log data into unified feature information structures. Each feature information structure includes, for example, a vector representing the semantic content of related text documents, scalar values representing anomaly scores from communication logs, and categorical values representing threat types and attack methods. The server stores the feature information in memory and associates each structure with a threat instance identifier. This unification enables the processor to evaluate threats using both semantic indicators and observed network behavior, which improves detection precision and reduces false positives compared to systems that process these data sources independently.

The server implements the reliability evaluation unit using one or more deep-learning models. In one embodiment, the server uses a feed-forward neural network with multiple hidden layers. The input layer receives the unified feature information, including at least (i) the semantic feature vector derived from the transformer model, (ii) anomaly scores derived from communication logs, (iii) numerical indicators of source type reliability, (iv) measures of content consistency across documents, (v) counts of past occurrences of similar threats, and (vi) measures of information update frequency. Hidden layers apply linear transformations and non-linear activation functions such as rectified linear units. The output layer produces a continuous reliability score between zero and one and, in some embodiments, a discrete priority level obtained by applying thresholding to the reliability score.

The server trains the deep-learning model using supervised learning. The server constructs training samples from historical data in which past threat instances are labeled according to whether they led to actual security incidents and according to the effectiveness of applied countermeasures. The server uses a loss function such as binary cross-entropy or focal loss to measure error between predicted reliability scores and ground-truth labels. The server updates model weights using gradient descent or a variant such as adaptive moment estimation. The server optionally uses data augmentation techniques, such as injecting noise into input features or sampling different time windows, to improve robustness. By training on historical correlations between features and actual incident outcomes, the model enables the processor to prioritize threats that historically correspond to real incidents, thereby reducing unnecessary processing and communication for low-value events.

The server implements the countermeasure generation unit as a software module that constructs prompt sentences for a generative AI model. The server encodes feature information and evaluation results into a structured textual description. For example, the server may construct a prompt sentence such as:
“Given the following environment description and detected threat, propose a prioritized list of specific and concrete security countermeasures. Include firewall rules, endpoint protection settings, configuration changes, and user awareness messages. Environment: [environment details]. Threat: [threat description including threat type, anomaly scores, affected resources, reliability score, and priority level].”

The server sends the prompt sentence as text to a generative AI model. In one embodiment, the generative AI model is a transformer-based language model with multiple encoder-decoder layers, trained on large corpora of technical documentation and security-related text. The model processes the prompt sentence and generates an output sequence containing countermeasure candidates, recommended priorities, and explanatory information. The server receives the generated text via an application programming interface.

The server parses the generated text using syntactic and semantic parsing rules and extracts machine-executable components. For example, if the generative AI model outputs a recommendation such as “Block incoming TCP connections from 203.0.113.45 to port 443 on the perimeter firewall,” the server converts this recommendation into a configuration change command in the syntax of the target network device. The server maps high-level actions such as “block IP address” or “enforce multi-factor authentication” to low-level commands or application programming interface calls appropriate for specific devices, such as firewall configuration commands or endpoint policy updates.

The server implements the countermeasure execution unit as a module that sends these configuration change commands and control requests to system elements. The server uses secure channels, such as secure shell or HTTPS, to connect to network devices, monitoring devices, and configuration management devices. The server transmits commands to modify access control lists, update intrusion detection signatures, set rate limits, or apply update programs to operating systems and applications. The server receives acknowledgments or error messages from devices and stores execution results, including status codes and timestamps, in the memory. By programmatically controlling multiple system elements based on unified evaluation results, the server reduces the delay between threat detection and protective action and reduces configuration inconsistencies that could arise from manual operations.

The server implements the information provision unit as a module that generates technical explanation outputs and non-expert user-oriented outputs. For technical users, the server composes detailed reports that include feature information, reliability scores, priority levels, and descriptions of executed countermeasures. For non-expert users, the server uses the generative AI model to transform technical descriptions into simplified language. For example, the server may construct a prompt sentence such as:
“Rewrite the following technical security alert into clear and simple instructions suitable for non-technical employees. Use short sentences and avoid jargon, but keep the key risk and required actions. Technical alert: [technical text describing the threat and recommended user actions].”

The server sends this prompt sentence to the generative AI model and receives simplified explanation text. The server then delivers this text to terminals, which display the explanations in notifications or message dialogs. This arrangement reduces processing load on terminals, because the complexity of language transformation is handled centrally by the server.

The terminal executes a client application that communicates with the server. The terminal periodically sends device status data, such as installed software versions and security configuration parameters, to the server. The server incorporates this device status data into the environment details included in prompt sentences and into the feature information used by the reliability evaluation unit. The terminal receives alerts and recommended actions from the server and displays them to the user. The terminal may present options such as “Apply update,” “Acknowledge warning,” or “Report suspicious message.” When the user selects an option, the terminal sends a corresponding command or acknowledgment back to the server, allowing the server to track user compliance and adjust risk assessments for the device or user.

The user operates the terminal to respond to alerts and instructions presented by the server. The user may, for example, confirm application of an update, refrain from opening a suspicious attachment, or forward a suspicious message for further analysis. The server records these user actions and incorporates them into historical data used for model retraining. By including user behavior as part of the training data, the system can learn patterns that distinguish benign from harmful user interactions and refine its prioritization of threats.

The server, by integrating these modules and data flows, produces technical effects beyond mere automation of human judgment. The unified feature information structure allows the processor to execute fewer and more targeted database queries, reducing main-memory and disk access overhead and thereby decreasing processing latency. The deep-learning-based reliability evaluation uses high-dimensional representations and multiple correlated factors, which improves the accuracy and robustness of threat prioritization in comparison to simple heuristic scoring. This improved accuracy directly reduces the number of unnecessary countermeasure executions and superfluous alerts transmitted over the communication network, thereby reducing communication load and conserving computational resources on both the server and the terminals.

The structured use of prompt sentences for interaction with the generative AI model also contributes to technical improvement. By constructing prompt sentences according to predefined templates that include explicit fields for threat type, anomaly scores, affected resources, and reliability scores, the server ensures that responses from the generative AI model are more deterministic and better aligned with internal data structures. This structure makes it possible to parse and transform model outputs into low-level commands systematically, reducing the probability of parsing errors and misconfigurations. The server logs prompt sentences and corresponding model outputs, enabling reproducible and auditable operation. These characteristics improve the reliability and maintainability of the computer system.

The server further improves computer technology by offloading complex reasoning and language transformation from terminals to the centralized environment. Because the server performs heavy computations, including natural language processing, deep learning inference, statistical anomaly detection, and generative modeling, the terminals can remain relatively lightweight, conserving battery power and local computational resources. At the same time, the server's centralized processing allows optimization of hardware resources, such as sharing the same graphics processing units across multiple concurrent tasks and models.

In some embodiments, the server uses alternative architectures and algorithms. For example, the reliability evaluation unit may use a recurrent neural network or a graph neural network instead of a feed-forward neural network, incorporating temporal sequences of events or relationships among entities as additional input. The analysis unit may use a convolutional neural network to process sequences of log records as time-series signals, or may use clustering algorithms to identify groups of devices exhibiting similar anomalous behavior.

The countermeasure generation unit may use rule-based post-processing to validate or adjust recommendations from the generative AI model before executing configuration changes, thereby enforcing safety constraints such as avoiding blanket blocking of entire address ranges.

In another embodiment, the server uses multiple generative AI models. The server may use a first generative AI model specialized in generating technical configuration instructions, with prompt sentences such as:
“Based on the following high-level security recommendation, generate specific firewall configuration commands for a generic access control device syntax: [high-level recommendation].”

The server may use a second generative AI model specialized in end-user communication, with prompt sentences such as:
“Explain to office employees why clicking on links in unsolicited emails may be dangerous and what they should do instead, in no more than five short sentences.”

The server selects an appropriate model based on the type of required output and routes prompt sentences accordingly.

In yet another embodiment, the server modifies the structure of feature information to include device-specific constraints, such as maximum allowable latency or bandwidth limits. The countermeasure generation unit incorporates these constraints into prompt sentences, guiding the generative AI model to propose countermeasures that respect performance requirements. This configuration reduces the risk that a security countermeasure will unintentionally degrade network performance beyond acceptable thresholds.

The described configurations and variations demonstrate that the server, by implementing structured data models, specific algorithms, and controlled interactions with a generative AI model, improves the performance, accuracy, and reliability of computer-implemented security monitoring and automated response. The system is not limited to automating human decisions; rather, it introduces new internal data representations, specialized evaluation and control flows, and coordinated device control strategies that would be impractical to execute manually and that result in measurable technical advantages such as faster threat mitigation, reduced false alerts, lower communication overhead, and more efficient utilization of processing and storage resources.

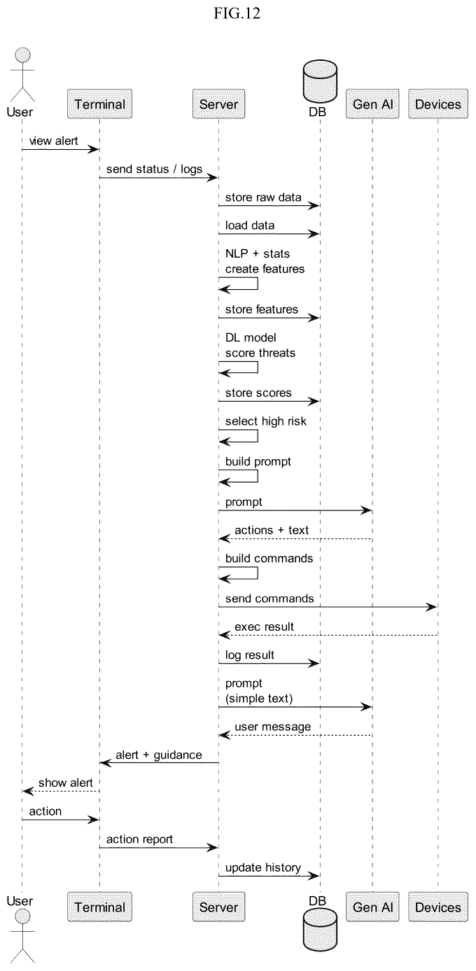

The following describes the processing flow using FIG. 12.

### Step 1:

The server acquires raw security-related data from external information sources and internal system elements.

The server receives, as input, network-retrieved text data from news distribution services, social information sharing services, electronic bulletin services, and record publication services via HTTP/HTTPS, and communication log data from network devices and monitoring devices via syslog, an application programming interface, or secure file transfer.

The server parses HTTP responses and log messages, converts character encodings to a unified format such as UTF-8, and extracts fields such as timestamps, source identifiers, and message bodies. As output, the server generates structured records of text data and structured records of communication log data, each stored in corresponding tables or collections in a database with keys including document identifiers, device identifiers, collection times, and collection batch identifiers.

### Step 2:

The server normalizes and indexes the collected data for efficient downstream processing.

The server receives, as input, the raw structured records produced in Step 1. The server removes markup such as HTML tags from text data, normalizes whitespace, and segments documents into title fields and body fields. For communication log data, the server standardizes address formats, protocol labels, and port representations. The server then writes the normalized data into database structures with indices on fields such as time, source type, and threat-related keywords. As output, the server produces normalized and indexed records that can be retrieved quickly based on query conditions, reducing input/output overhead and improving cache locality during later analysis.

### Step 3:

The server performs natural language processing on normalized text data to extract semantic features.

The server receives, as input, normalized text records from Step 2. The server runs a tokenizer to split each document body into tokens, applies a part-of-speech tagger to assign grammatical categories to each token, and executes a syntactic parser to identify sentence boundaries and dependency relations. The server then feeds token sequences into a transformer-based language model to compute contextual embeddings for each token and aggregates these embeddings into a fixed-length vector representation for each document using pooling operations such as average pooling or attention-based pooling. The server additionally extracts named entities and security-related phrases. As output, the server generates, for each document, a semantic feature vector and a list of extracted entities and phrases, and stores them in feature tables linked to the original text records.

### Step 4:

The server performs statistical analysis and anomaly detection on communication log data.

The server receives, as input, normalized communication log records from Step 2. The server groups log entries into fixed-length time windows, for example one-minute windows, based on timestamps. Within each window, the server computes aggregate statistics per source address and per destination service, including counts of connections, total bytes, mean and maximum packet rates, and distributions of ports and protocols. The server constructs feature vectors representing these statistics for each address or service and applies an anomaly detection algorithm such as isolation forest or an autoencoder. The algorithm compares current behavior to learned baseline patterns and outputs anomaly scores indicating degrees of deviation. As output, the server produces anomaly feature records that include, for each address or service, a set of statistical metrics and a corresponding anomaly score.

### Step 5:

The server correlates semantic features and anomaly features into unified threat feature information.

The server receives, as input, the semantic feature vectors and entity lists from Step 3 and the anomaly feature records from Step 4. The server identifies potential relationships between documents and communication entities, for example by matching indicators such as addresses, domains, or malware names appearing in text with corresponding fields in communication logs. For each correlated set, the server constructs a unified feature information structure that includes the document semantic vector, the anomaly metrics, the anomaly score, and categorical attributes such as threat type and attack method inferred from keywords and entities. The server assigns a threat instance identifier to each unified feature information structure. As output, the server stores unified feature information records that serve as inputs for reliability evaluation.

### Step 6:

The server evaluates the reliability and priority of each threat instance using a deep-learning model.

The server receives, as input, unified feature information records from Step 5 and historical training parameters stored in the memory. For each threat instance, the server assembles an input vector combining semantic features, anomaly scores, source type indicators, content consistency measures, counts of similar past threats, and information update frequency metrics. The server feeds this input vector into a trained deep neural network, which performs successive matrix multiplications, adds bias terms, and applies non-linear activation functions across multiple hidden layers. At the output layer, the server applies a sigmoid or similar function to compute a reliability score between zero and one and derives a priority level by comparing the score to predefined thresholds. As output, the server produces reliability evaluation records including the threat instance identifier, the reliability score, and the priority level.

### Step 7:

The server selects threat instances requiring automated countermeasure generation.

The server receives, as input, reliability evaluation records from Step 6. The server compares the priority level of each threat instance against one or more threshold conditions, such as “High” or “Critical” priority. For threat instances that meet the condition, the server retrieves corresponding feature information and context such as affected devices and current configurations from the database. The server compiles a list of candidate threat instances for which countermeasures should be generated. As output, the server produces a subset of threat instance records annotated as requiring countermeasure generation along with associated environmental context.

### Step 8:

The server constructs prompt sentences for a generative AI model based on selected threat instances.

The server receives, as input, the subset of threat instance records and their unified feature information from Step 7. For each threat instance, the server formats a textual description that includes threat type, anomaly scores, affected resources, reliability score, priority level, and relevant environmental constraints such as device types and performance requirements. The server embeds this description into a prompt template, generating a prompt sentence such as:
“Given the following environment description and detected threat, propose a prioritized list of specific and concrete security countermeasures. Include firewall rules, endpoint protection settings, configuration changes, and user awareness messages. Environment: [environment details]. Threat: [threat description including threat type, anomaly scores, affected resources, reliability score, and priority level].”

The server may also construct alternative prompt sentences for explanation generation, such as:
“Rewrite the following technical security alert into clear and simple instructions suitable for non-technical employees. Use short sentences and avoid jargon, but keep the key risk and required actions. Technical alert: [technical text].”

As output, the server generates a set of prompt sentences ready for transmission to the generative AI model.

### Step 9:

The server obtains countermeasure candidates and explanations from the generative AI model.

The server receives, as input, the prompt sentences from Step 8. The server sends each prompt sentence as text to a generative AI model via an application programming interface, using the communication interface to establish a secure connection. The generative AI model processes the prompt and returns a response text containing countermeasure descriptions, recommended priorities, and explanatory narratives. The server reads the response, segments it into logical sections using delimiter patterns or headings, and extracts proposed actions and associated reasoning. As output, the server generates intermediate representation records that encode each proposed countermeasure as textual instructions with associated metadata such as relevance, recommended priority, and explanation.

### Step 10:

The server converts proposed countermeasures into device-specific configuration change commands and control requests.

The server receives, as input, the intermediate representation records from Step 9 and device capability information stored in the database. For each proposed action, the server determines the target system elements based on attributes such as device type, role, and network position.

The server maps high-level actions, for example “block incoming connections from [address] to port [number] on the perimeter,” to low-level command templates appropriate for specific device families. The server substitutes concrete parameters, such as addresses, ports, and rule names, into these templates to generate executable commands or application programming interface requests. The server validates generated commands against safety policies, such as preventing blocking of entire address ranges without explicit criteria. As output, the server produces a set of configuration change commands and control requests ready for execution.

### Step 11:

The server executes configuration changes and control requests on system elements.

The server receives, as input, the configuration change commands and control requests from Step 10. The server establishes secure sessions with network devices, monitoring devices, and configuration management devices using protocols such as secure shell or HTTPS. The server transmits commands to modify access control lists, install or update intrusion detection signatures, adjust rate limits, or trigger update program deployment on managed devices. The server reads responses from devices, which may include success indicators, error codes, or diagnostic messages, and records these responses along with timestamps and affected threat instance identifiers. As output, the server generates execution result records that reflect the status of each applied countermeasure.

### Step 12:

The server compiles technical reports and non-expert user messages based on evaluation and execution results.

The server receives, as input, reliability evaluation records from Step 6, unified feature information from Step 5, countermeasure descriptions from Step 9, and execution result records from Step 11. The server assembles technical reports that link threat instances to their features, reliability scores, priority levels, generated countermeasures, and execution outcomes. For non-expert messages, the server constructs technical alert summaries and uses them to build prompt sentences for the generative AI model, such as the user-oriented rewriting prompt described in Step 8. The server sends these prompt sentences to the generative AI model and obtains simplified explanation text. As output, the server produces formatted technical reports and plain-language notification texts, each associated with specific users or devices.

### Step 13:

The server delivers notifications and guidance to terminals.

The server receives, as input, the formatted technical reports and plain-language notification texts from Step 12. The server determines destination terminals based on user accounts, device identifiers, or organizational units and packages appropriate messages into payloads. For administrative users, the server sends technical reports through secure web dashboards or administrative applications. For general users, the server sends simplified notifications via push notification services or other messaging channels. As output, the server transmits alert payloads to terminals, each payload including a threat summary, risk level, and clear instructions such as “Do not open attachments from unknown senders” or “Install the pending security update now.”

### Step 14:

The terminal displays alerts and interacts with the user.

The terminal receives, as input, alert payloads transmitted by the server in Step 13. The terminal parses payloads to extract message contents, risk levels, and available user actions.

The terminal displays an alert screen or notification panel, showing key information and buttons such as “Apply update,” “Acknowledge,” or “Report suspicious message.” When the user selects an action, the terminal packages the choice along with device status information into a response message and sends the response back to the server. As output, the terminal generates user action reports that reflect the user's decisions and, in some cases, triggers local changes such as initiating an update process or quarantining a file at the user interface level.

### Step 15:

The user responds to alerts and follows recommended actions.

The user receives, as input, visual or auditory alerts displayed by the terminal in Step 14. The user interprets simplified explanations and decides whether to follow suggested actions, such as refraining from clicking suspicious links, confirming installation of update programs, or submitting suspicious content for further analysis. The user interacts with the terminal via touch, keyboard, or pointing devices to select options. As output, the user produces explicit responses that the terminal forwards to the server, and may also change behavior, such as avoiding risky communication channels, which indirectly affects future communication log data.

### Step 16:

The server records feedback and updates historical data for model improvement.

The server receives, as input, user action reports from Step 14 and execution result records from Step 11. The server correlates these inputs with corresponding threat instances and timestamps to determine which threats resulted in real incidents or near misses and which countermeasures were effective. The server labels threat instances accordingly and updates historical datasets used for training or fine-tuning the deep-learning model and for adjusting prompt sentence templates. As output, the server generates updated training records and configuration parameters that can be applied during future retraining cycles, thereby improving the accuracy and efficiency of subsequent threat evaluation and countermeasure generation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information provision systems that evaluate the reliability of network-distributed content mainly focus on source attributes and content patterns, and then present a fixed-form warning or score to end users. Such systems typically execute a pipeline in which a processor collects articles and posts from multiple network sources, performs natural language processing to extract keywords, and applies a machine learning model to assign a reliability score. However, these systems do not adapt their internal computation or their output format to the user's current emotional state, and thus cannot adequately control how information is perceived or acted upon by different users in different emotional conditions. From a computer technology standpoint, existing architectures treat reliability evaluation and user interface control as loosely coupled or static components. A server may compute a reliability score once per item and store it, while a client device merely renders the score and a generic warning. The server does not receive or process fine-grained emotion-related signals from the client, such as voice tone, facial expression, or interaction patterns, and therefore cannot alter its generative summarization behavior in a data-driven way. As a result, the same deterministic summary and warning text is delivered regardless of whether a user is calm, anxious, or angry, which can lead to suboptimal human-computer interaction and even amplify misinformation diffusion when users are emotionally aroused.

In addition, conventional systems that use generative AI models, such as large language models, generally apply static prompt templates that do not incorporate machine-readable representations of user emotion or dynamically computed reliability features. The processor typically feeds the generative AI model with generic instructions (“summarize this article”) and does not leverage its own internal reliability evaluation pipeline or its own emotion inference pipeline when constructing the prompt sentence. Consequently, the generative AI model cannot adapt its tone, level of detail, or explanation strategy based on a combination of reliability evaluation and user emotion signals, and the computing platform fails to exploit available information to control generative behavior at runtime.

Furthermore, existing client-side emotion recognition modules, where present, are often deployed only for analytics or user profiling and are not integrated into a closed feedback loop that controls server-side processing. The server architecture and communication protocol are not structured to receive an emotion state vector as a first-class input that influences the construction of prompt sentences and the selection of output layouts. The processor, therefore, does not provide a technical mechanism to dynamically couple recognition of user emotional state with reliability-aware generation and presentation of content, which limits the system's ability to mitigate the risk of harmful or misleading information being consumed or shared inappropriately.

There is thus a need for a computer-implemented system in which a processor integrates (i) network-based information collection and natural language processing, (ii) machine-learning-based reliability evaluation, (iii) multi-modal user emotion recognition executed in cooperation with a user terminal, and (iv) adaptive control of a generative AI model through dynamically generated prompt sentences. In particular, there is a need to improve the internal control logic and data structures of the server processor so that the processor can generate reliability- and emotion-aware prompt sentences, invoke a generative AI model in a controlled manner, and dynamically adjust the layout and emphasis of information presented to the user terminal. Such improvements to the server-side computation and client-server interaction can enhance the robustness, safety, and effectiveness of computer-based information provision under diverse emotional conditions of users.

The specific processing by the specific processing unit 290 of the data processing device 12 in Example 2 is realized by the following means.

The present invention provides a server comprising a processor configured to acquire, via a network, text information and related meta information from a plurality of external information provision units or information provision services, to execute natural language processing including morphological analysis, part-of-speech tagging, sentence structure analysis, keyword extraction, and document embedding generation on the acquired text information, to compute, by using a machine learning model and based on the generated features, source attributes, temporal attributes, cross-source similarity, and social reaction indicators, a reliability score and a reliability class for each piece of text information, to receive, from a user terminal, multi-modal emotion-related inputs including at least one of a speech recognition result, a facial expression feature, and a behavioral feature derived from interaction logs, to calculate, by using an emotion estimation model, an emotion state vector including intensities of a plurality of user emotions, to generate, based on the reliability score, the reliability class, the emotion state vector, and the category and source information of the text information, a structured prompt sentence that explicitly specifies an output format and a writing style for a generative AI model, to input the prompt sentence to the generative AI model so as to cause the generative AI model to generate a summary sentence and a reliability explanation sentence, and to dynamically control, according to at least one of the reliability score, the reliability class, and the emotion state vector, a presentation layout, display order, and emphasis parameters for outputting the generated sentences and at least part of the original text information to the user terminal. This enables an integrated computer-implemented pipeline in which the server processor not only evaluates the reliability of network-distributed information and recognizes user emotion in cooperation with the user terminal, but also adaptively controls the behavior of a generative AI model and the structure of the output user interface based on machine-readable reliability and emotion signals, thereby improving the technical functioning of the information provision system by reducing the likelihood that unreliable information is presented in a manner that amplifies user anxiety or anger and by providing reliability-aware, emotion-adaptive summaries and explanations in a controlled and reproducible server-side computation flow.

The term “system” refers to a combination of hardware and software components, including at least one processor and at least one memory device, that cooperatively execute programmed instructions to perform the functions described in the claims.

The term “processor” refers to one or more hardware processing units, such as a central processing unit or a graphics processing unit, configured to execute machine-readable instructions and to perform arithmetic, logic, control, and input/output operations.

The term “network” refers to a logical and physical communication infrastructure, including wired and wireless communication paths, by which multiple information processing devices exchange data using one or more communication protocols.

The term “external information provision unit” refers to a remote information processing device or service that is accessible via a network and that provides content including text information and associated metadata.

The term “information provision service” refers to a network-accessible service that distributes or hosts content including text information, such as a news distribution service, a social media service, a blog distribution service, or an electronic bulletin board service.

The term “text information” refers to content represented in a natural language character sequence, including but not limited to news articles, social media posts, blog articles, forum posts, and associated textual descriptions.

The term “meta information” refers to auxiliary data associated with text information, including but not limited to timestamps, categories, source domains, identifiers, engagement counts, and other descriptive attributes.

The term “information collection means” refers to functionality implemented by the processor and memory that causes the system to acquire text information and meta information from external information provision units or information provision services via a network and to store such information as internal records.

The term “natural language processing means” refers to functionality implemented by the processor and memory that causes the system to perform computational analysis of text information, including segmentation, syntactic analysis, and semantic feature extraction, to obtain machine-usable representations of the content.

The term “morphological analysis” refers to processing that segments a character sequence into units such as words or morphemes and assigns grammatical categories or part-of-speech labels to the units.

The term “part-of-speech tagging” refers to processing that assigns grammatical category labels, such as noun, verb, adjective, or adverb, to tokens or words in text information.

The term “sentence structure analysis” refers to processing that determines syntactic relationships within a sentence, such as phrase boundaries, dependency relations, or constituency structure, in order to represent the grammatical organization of the sentence.

The term “keyword extraction” refers to processing that identifies words or phrases that are estimated to be important or representative of the main topics or concepts in the text information.

The term “document embedding generation” refers to processing that converts text information into one or more numerical vectors that represent semantic or contextual features of the document in a continuous vector space.

The term “feature” refers to a numerical or categorical value derived from text information, source attributes, temporal attributes, social indicators, or other inputs, that is used as input to a machine learning model or other computational process.

The term “reliability evaluation means” refers to functionality implemented by the processor and memory that causes the system to compute, using a machine learning model and multiple types of features, a reliability score and a reliability class for each piece of text information.

The term “machine learning model” refers to a trained computational model, such as a neural network, decision tree ensemble, or other statistical model, whose parameters have been adjusted based on training data so that the model can output predictions, scores, or classifications from input features.

The term “reliability score” refers to a numerical value that indicates an estimated degree of trustworthiness or correctness of text information, typically represented on a continuous or quasi-continuous scale.

The term “reliability class” refers to a discrete label, such as high, medium, or low, that categorizes text information according to its estimated reliability based on the reliability score and optionally additional rules.

The term “source attributes” refers to properties associated with an information source, including but not limited to source type, source domain, prior reliability history, prior false-information history, and other descriptive characteristics.

The term “source type” refers to a category indicating a class of information source, such as a public institution, a mass media outlet, an individual-operated site, or a social networking platform.

The term “source domain” refers to an identifier or domain name associated with a source on a network, representing the origin of the text information.

The term “false information history” refers to stored data indicating that certain past items from a given source or similar content have been determined or labeled as incorrect, misleading, or fake.

The term “reliability score history” refers to past values of reliability scores calculated for information from a given source or about a given topic, which can be used as part of current reliability evaluation.

The term “temporal attribute” refers to information related to time, such as publication time, elapsed time from publication, update times, or correction times associated with text information.

The term “cross-source similarity” refers to a measure of similarity, such as a numerical similarity score, between one piece of text information and other pieces of text information provided by different sources but relating to the same or similar topics.

The term “social reaction indicator” refers to a quantitative or qualitative value that represents how users or audiences have responded to text information on social platforms, including but not limited to emotion distributions, engagement levels, and diffusion speeds.

The term “emotion distribution” refers to a set of values indicating estimated proportions or intensities of different emotion categories, such as joy, anger, anxiety, or neutrality, expressed in user responses to text information.

The term “degree of diffusion” refers to a measurement indicating how widely and rapidly text information has been propagated or shared across users or platforms over time.

The term “user terminal” refers to an information processing device operated by a user, such as a mobile communication terminal, a smartphone, a tablet device, a personal computer, or any other computing device with input and output capabilities.

The term “user emotion recognition means” refers to functionality implemented by the processor and memory that causes the system to receive emotion-related input data from a user terminal and calculate a machine-readable representation of the user's emotional state.

The term “speech recognition result” refers to text data obtained by applying an automatic speech recognition process to audio data captured from a user.

The term “facial expression feature” refers to numerical or categorical data that represent aspects of a user's facial expression, such as positions of facial landmarks or inferred expression labels, derived from image data.

The term “behavioral feature” refers to numerical or categorical data that represent a user's interaction behavior with a user interface, including but not limited to touch patterns, scroll velocity, tapping frequency, and session duration.

The term “emotion estimation model” refers to a machine learning model configured to receive emotion-related features, including but not limited to speech-derived, image-derived, and behavior-derived features, and to output estimates of emotion intensities or categories.

The term “emotion state vector” refers to a numerical vector whose elements represent intensities or probabilities of multiple emotion types of a user, such as anger, anxiety, interest, and joy, at a given time.

The term “generative artificial intelligence control means” refers to functionality implemented by the processor and memory that causes the system to construct prompt sentences for a generative AI model based on reliability and emotion information, to invoke the generative AI model, and to process and manage the generated output.

The term “generative AI model” refers to a generative artificial intelligence model, such as a large language model or other text generation model, configured to receive input conditions including text prompts and to output new text such as summaries and explanations.

The term “prompt sentence” refers to a text input that specifies instructions, constraints, and context to be provided to a generative AI model in order to guide the form, style, and content of the generated output.

The term “summary sentence” refers to a sentence or plurality of sentences that concisely describe the main content of text information in a shorter form than the original.

The term “reliability explanation sentence” refers to a sentence or plurality of sentences that explain, in natural language, how and why a certain reliability score or reliability class has been assigned to text information, including references to source attributes, cross-source agreement, and uncertainty factors.

The term “information provision means” refers to functionality implemented by the processor and memory that causes the system to format, arrange, and output text and related elements to a user terminal according to one or more presentation rules.

The term “presentation layout” refers to an arrangement of visual elements on a display, including positions, sizes, and relationships of text blocks, icons, warnings, and control elements.

The term “display order” refers to the sequence in which different pieces of content, such as a summary sentence, a reliability explanation sentence, and an original article body, are arranged and presented on a user interface.

The term “display color” refers to visual color attributes applied to text, backgrounds, or graphical elements to convey emphasis, warnings, or neutrality.

The term “font” refers to typographical attributes of text, including typeface, size, weight, and style, that can be adjusted to control readability and emphasis.

The term “warning message” refers to a text element that alerts a user to a risk or uncertainty regarding the reliability or interpretation of text information.

The term “operation button” refers to a user interface control component that can be selected or activated by a user to trigger a function, such as expanding detailed information, accessing external sources, or submitting feedback.

The term “high-reliability information source” refers to an information source that is designated or inferred as having a comparatively high degree of trustworthiness based on historical reliability scores, domain type, or other criteria.

The term “false information item” refers to a piece of text information that has been determined or labeled as incorrect, misleading, or substantially inconsistent with trusted references.

The term “output format” refers to the structural form of text generated by a generative AI model, including sectioning, numbering, paragraphing, and the inclusion or exclusion of specific content elements.

The term “writing style” refers to stylistic characteristics of generated text, such as tone, level of formality, degree of neutrality, and use or avoidance of certain expression types.

The term “tone” refers to an overall communicative attitude expressed in text, such as neutral, calming, or emotionally restrained, as controlled by instructions in a prompt sentence.

The term “background explanation” refers to additional text generated to describe underlying context, causes, or related information that helps a user understand a topic beyond the immediate content of the original text information.

The term “trusted source” refers to a class of information source, such as a public institution or established news organization, that is treated as generally reliable for the purpose of verification and cross-referencing.

In one embodiment, a server executes a server-side program on one or more processors to implement the functions of information collection, natural language processing, reliability evaluation, user emotion recognition cooperation, generative AI control, and information provision. A terminal executes a client-side program on a processor of a user device to implement functions of user interaction, local emotion-related feature extraction, and display control. A user operates the terminal to request information, review summaries and explanations, and provide feedback.

### A. Hardware and Basic Software Configuration

The server uses a general-purpose information processing apparatus including at least one central processing unit (CPU), at least one graphics processing unit (GPU), a main memory, a non-volatile storage device, and a network interface. The CPU may be a multi-core general-purpose processor. The GPU may be a general-purpose parallel processor configured to accelerate neural network inference, for example by supporting single-precision and half-precision matrix multiplication. The server uses an operating system for server devices and an application execution environment including a web server and an application framework.

The server uses, in one embodiment, a deep learning framework such as a generic tensor-based framework (e.g., a framework of the TensorFlow or PyTorch type), a natural language processing library such as a generic NLP toolkit (e.g., a toolkit of the spaCy or Hugging Face Transformers type), and a morphological analysis engine such as a generic morphological parser (e.g., a parser of the MeCab type). The server uses a relational database management system, such as a generic SQL database, to store collected data, features, and model outputs.

The terminal uses a mobile device, such as a smartphone or a tablet computer, including a CPU, a graphics controller, a display panel with a touch sensor, a microphone, a camera, and a wireless communication interface. The terminal uses a mobile operating system and executes a client application developed on a generic mobile application framework. The terminal uses platform-provided audio, camera, and network APIs, and a mobile inference library such as a lightweight neural network runtime (e.g., a runtime of the TensorFlow Lite type) for on-device emotion estimation.

### B. Server-Side Program Configuration and Data Structures

Server uses a modular program architecture. The server program includes an information collection module, a natural language processing module, a reliability evaluation module, a user emotion cooperation module, a generative AI control module, and an information provision module. The modules share data through a relational database and in-memory data structures.

Server stores text information and meta information in normalized tables. For example, the server defines an “articles” table with fields such as:
article id (primary key, for example a universally unique identifier),
source type (categorical field indicating types such as “public institution”, “media_service”, “social_platform”, “personal_site”),
source_domain (string field indicating the domain or service identifier),
title (text),
body text (text),
publish time (timestamp),
update time (timestamp),
category (string or enumerated type),
raw_metadata (structured field encoding original attributes),
reliability_score (floating point),
reliability_class (categorical),
processing_status (state field, e.g., “NLP_PENDING”, “RELIABILITY_READY”).

Server stores keyword and keyphrase results in separate tables, such as “article keywords” with article_id, token, and tfidf_score, and “article_keyphrases” with article id, phrase, and importance_score. Server stores document embeddings in an “article_embeddings” table or in a specialized vector store. Server stores social reaction statistics, such as emotion distributions and engagement metrics, in topic-level and article-level tables.

Server stores reliability features in a “reliability features” structure, which may be materialized as a table or generated on demand. Each reliability features record includes a concatenated vector of normalized numerical features and encoded categorical features. This data structure enables efficient batch input to a neural network model and improves throughput and cache locality compared to ad hoc feature gathering.

### C. Information Collection and Natural Language Processing

Server implements the information collection module using a scripting environment and an HTTP client library. The server uses a crawler framework to send network requests to multiple external information provision services, including news distribution services, social media systems, blog services, and bulletin board services. The server acquires HTML documents, structured JSON responses, and feed data (e.g., in RSS or Atom formats) and converts them into unified internal records.

Server uses an HTML parsing library to interpret document object models and extract article titles, paragraphs, headings, timestamps, and other meta information. The server converts heterogeneous representations into a common schema by mapping service-specific fields into the article table fields. This common schema, implemented as normalized tables, improves data management by enabling uniform indexing, querying, and feature extraction, thereby reducing storage redundancy and query complexity.

Server uses the natural language processing module to perform morphological analysis, part-of-speech tagging, sentence structure analysis, keyword extraction, and embedding generation. The server calls a morphological analysis engine, loading a language-specific dictionary into memory, and passes each article body text as input. The engine returns sequences of tokens with attributes including part-of-speech tags and base forms.

Server implements TF-IDF computation using a matrix-based algorithm in a numerical library. The server constructs a document-term matrix for a corpus of articles, computes term frequencies per document, and computes inverse document frequencies across the corpus. The server multiplies these matrices to obtain TF-IDF scores for each token. By storing these scores in a structured table, the server enables subsequent computation of similarity and importance in a computationally efficient manner using indexed queries rather than re-running text analysis, which improves processing speed for later stages.

Server generates contextual keyphrases using a document encoder based on a transformer architecture. The encoder, for example, uses multiple self-attention layers, positional encodings, and feed-forward sublayers. The server encodes candidate n-grams and the whole document into embedding vectors, computes cosine similarity between candidate vectors and the document vector, and selects those candidates with high similarity as keyphrases. This approach exploits the non-local attention mechanism of the transformer architecture to capture context beyond simple word frequency, thereby improving the semantic precision of extracted keyphrases.

Server generates sentence or document embeddings using a bi-encoder architecture. For example, the server uses a dual-tower neural network with shared encoder parameters to map sentences into a fixed-dimensional vector space. The server uses these embeddings to compute cross-source similarity and to cluster texts. By precomputing and indexing these vectors, the server can perform approximate nearest neighbor search or clustering in sublinear time with respect to the number of documents, improving performance for large-scale information collections.

### D. Reliability Evaluation Model and Training

Server implements the reliability evaluation module using a machine learning model such as a feedforward neural network, gradient boosting model, or a combination thereof. In one embodiment, the server uses a neural network with an input layer matching the length of the feature vector, two or more hidden layers with non-linear activation functions (such as rectified linear units), and an output layer that produces a single reliability_score and optionally class probabilities via a softmax activation.

Server trains the reliability model offline using a training dataset of labeled articles. The training dataset includes labels such as “high reliability”, “medium_reliability”, and “low_reliability”, derived from human assessment, cross-checks with official sources, and historical corrections. The server uses a supervised learning procedure: the server constructs input feature vectors from source attributes (e.g., one-hot encoded source types), embedding-based similarity scores, temporal features, and social reaction indicators. The server normalizes numeric features using mean and variance statistics stored in model metadata.

Server defines a loss function such as cross-entropy for classification or a combination of mean squared error for score regression and cross-entropy for class labels. The server applies a weight update algorithm such as stochastic gradient descent or adaptive gradient methods. During training, the server computes gradients of the loss with respect to each model parameter by backpropagation and updates the parameters accordingly. The server may employ data augmentation, such as random masking of less important features or noise injection into non-critical numeric inputs, to improve robustness and generalization. These training details demonstrate that the model's internal parameters are derived from data and not from hand-coded business rules.

Server, at runtime, loads the trained model and normalization parameters into memory. The server constructs a feature vector for each new article by concatenating normalized numerical features and encoded categorical features. The server processes multiple feature vectors in batches, using GPUs for matrix multiplications in the hidden layers. By batching and offloading to GPU, the server improves throughput and reduces per-sample latency compared with scalar CPU-only implementations. This results in a concrete technical effect: accelerated evaluation of reliability scores for large volumes of incoming information.

Server uses the model output to compute a reliability score in the range [0, 1] and class probabilities. The server maps the reliability_score to a reliability_class using threshold values stored in configuration (e.g., score ≥0.8: “high”, 0.5-0.8: “medium”, <0.5: “low”).

The server further adjusts reliability_score by applying rule-based corrections that reference a table of known high-reliability sources and a table of known false information items whose embeddings are stored. If an article's embedding is highly similar (above a similarity threshold) to a known false item, the server reduces the reliability_score. This hybrid approach combines learned patterns and explicit similarity-based rules, leading to both interpretability and improved error detection.

### E. User Emotion Recognition Cooperation

Terminal implements a local emotion recognition pipeline using multi-modal inputs: voice, facial expression, and interaction behavior. The terminal uses the microphone to capture audio when the user consents, applies a speech recognition engine to convert audio to text, and uses a compact text-based emotion classifier implemented as a small neural network with an embedding layer and one or more dense layers. The classifier outputs emotion intensities such as anger, anxiety, and joy.

Terminal uses the camera to capture frames of the user's face and applies a face landmark detection algorithm that uses a convolutional neural network to detect keypoints. The terminal extracts geometric features such as distances and angles between facial landmarks and feeds them to a pre-trained expression classifier (e.g., a small convolutional neural network). The classifier outputs expression probabilities (e.g., sadness, anger, joy).

Terminal records touch and scroll events as structured logs. For example, the terminal accumulates a rolling window of scrolling velocities and tap intervals, stores them in a multi-dimensional feature vector, and feeds them to a lightweight behavioral classifier, such as a small feedforward network, that outputs behavioral states (e.g., “calm”, “restless”).

Terminal aggregates audio-based, expression-based, and behavior-based features into a unified feature vector and feeds this vector to an emotion fusion model, which may be a fully connected neural network with hidden layers that learn non-linear combinations of features from different modalities. The fusion model outputs an emotion_state_vector whose elements correspond to intensities of multiple emotions. Terminal transmits this vector, together with the current article_id and user identifier or session identifier, to the server.

This multi-modal approach uses non-trivial fusion rules and neural architectures that cannot be easily replicated by manual rule-based systems, and it transforms raw sensor signals into compact numerical representations that can be interpreted by the server. By offloading part of the computation to the terminal and sending only compact vectors, the system reduces communication load and helps to preserve user privacy, both of which are technical improvements over approaches that would send raw audio and video streams to the server.

### F. Generative AI Control and Prompt Sentence Construction

Server uses the generative AI control module to construct prompt sentences and to control a generative AI model. The server does not simply instruct the model to “summarize” text; instead, the server encodes reliability and emotion information into the prompt in a structured and systematic manner, which leads to a concrete improvement in the behavior and outputs of the generative AI model.

Server first interprets the emotion_state_vector according to thresholds. For example, the server maps an anxiety intensity above a threshold to “user_is_anxious”, an anger intensity above a threshold to “user_is_angry”, and an interest intensity above a threshold to “user_is_highly_interested”. The server then selects a prompt template corresponding to the combination of user_is_anxious, user_is_angry, user_is_highly_interested, and the reliability_class of the article. The templates are stored as structured text with placeholders for reliability_score, reliability_class, and article body text.

Server, for an anxious user and an article with medium reliability, may construct the following prompt sentence:
“The user may feel anxious about the following news article.

The reliability score of this article is 0.55 (medium).

Read the article body below and perform the following tasks:
(1) Provide a neutral-tone summary of the article in up to four sentences, avoiding language that would excessively increase the user's anxiety.
(2) Explain in simple terms why the reliability is evaluated as medium, referring to the type of source, whether other major outlets report similar information, and any remaining uncertainties.
(3) Advise the user to consult official announcements from relevant public institutions or other well-established news organizations before drawing firm conclusions.
[Article body]
. . . ”

Server, for a user with high anger intensity, may construct another prompt sentence:
“The user may feel anger about the following news article.

Read the article body below and perform the following tasks:
(1) Summarize the factual content of the article in three to five sentences, avoiding aggressive, insulting, or inflammatory expressions.
(2) Present multiple viewpoints or interpretations that may exist regarding this topic, making clear that different stakeholders may hold different opinions.
(3) Encourage the user to consider the information in a balanced way and to avoid personal attacks or hostile language.
[Article body]
. . . ”

Server, for a highly interested user and a high-reliability article, may construct a prompt sentence:
“The user is highly interested in the following news article, which has a high reliability score of 0.87.

Read the article body below and perform the following tasks:
(1) Provide a concise summary of the main points of the article.
(2) Provide a detailed background explanation that includes relevant historical context, key concepts, and related events.
(3) Suggest additional reliable information sources or types of sources that the user may consult for deeper understanding.
[Article body]
. . . ”

Server passes the constructed prompt sentence to a generative AI model. The generative AI model may be a large language model using a transformer architecture with multiple attention layers. The server interacts with the model via an API, specifying parameters such as maximum output length, temperature, and decoding strategy. The server's dynamic prompt generation ensures that the model's internal generative process is guided by reliability and emotion signals that are not present in conventional static prompts.

This architecture yields a technical effect: by encoding machine-readable reliability and emotion information into text-level constraints, the server reduces the likelihood that the generative AI model will produce content that exaggerates risk or uses inflammatory language when the user is anxious or angry. The server therefore uses the generative AI model as a controlled component in a pipeline rather than as a black-box summarizer, thereby improving the overall safety and predictability of the system.

### G. Information Provision and Display Control

Server sends the outputs of the generative AI model, including the summary_sentence and reliability_explanation_sentence, together with reliability_score, reliability_class, and selected parts of the original article body, to the terminal in a structured response. The server may also include layout hints such as a warning_level or display_priority.

Terminal receives the response and uses a display control component to adjust the presentation. The terminal selects a layout profile based on the reliability_class and the emotion_state_vector stored locally. For example, when anxiety is high and reliability_class is “low”, the terminal displays the reliability_explanation_sentence and a warning message at the top of the screen in a high-contrast color and larger font size, while collapsing the full article body behind an expandable control. When interest is high and reliability_class is “high”, the terminal displays the summary prominently and provides buttons to access more detailed background information or related reliable articles.

Terminal uses the mobile operating system's graphics APIs to draw text blocks, icons, and control components. The terminal's adaptation of layout and emphasis reduces cognitive overload for users in stressed emotional states and reduces the chance of misinterpretation of low-reliability information. From a technical perspective, the terminal's dynamic UI control is driven by structured data from the server and does not require manual redesign for each case, contributing to a more responsive and adaptive human-machine interface.

### H. Technical Effects and Non-Abstract Improvements

Server and terminal, together, implement a closed-loop control architecture in which reliability evaluation, user emotion recognition, generative AI behavior, and user interface layout are mutually informed. This architecture produces several technical improvements beyond mere automation of human tasks:
Processing speed improvement: Server precomputes and stores document embeddings and reliability features, and uses batched GPU inference for both reliability evaluation and generative AI invocation, enabling real-time or near-real-time adaptation of content for many simultaneous users.
Accuracy improvement: Server's reliability model uses a rich feature space combining source attributes, temporal attributes, cross-source similarity, and social reaction indicators, and the server adjusts scores using similarity to known false information items. This combination reduces false positives and false negatives compared with simpler rule-based or single-feature approaches.
Data management improvement: Server uses normalized schemas and vector indices that support efficient querying, clustering, and cross-source comparison. This structure allows the server to reuse computed features for multiple downstream tasks (reliability, topic clustering, prompt construction), decreasing redundant computation and storage.
Communication efficiency: Terminal performs local multi-modal emotion estimation and sends only compact emotion_state_vectors rather than raw audio and video data, reducing network bandwidth and latency.
Computation efficiency and safety: Server constructs prompt sentences that incorporate quantitative reliability and emotion parameters, which influences the generative AI model's internal attention and decoding patterns. This reduces the need for repeated trial-and-error calls to the model and limits unsafe or misleading output, improving both computational efficiency and system robustness.

The described embodiments are not limited to the particular hardware or software products named above. Server may replace individual components with functionally equivalent general-purpose frameworks, and terminal may use alternative mobile or desktop platforms. Server may also host the generative AI model locally or access it as a remote service. Variations in neural network architectures are possible; for example, server may use convolutional networks or recurrent networks for some sub-tasks, and transformer-based architectures for others. Alternative training strategies, such as semi-supervised learning or reinforcement learning based on user feedback, may also be employed, provided that the processor still implements the functions set forth in the claims.

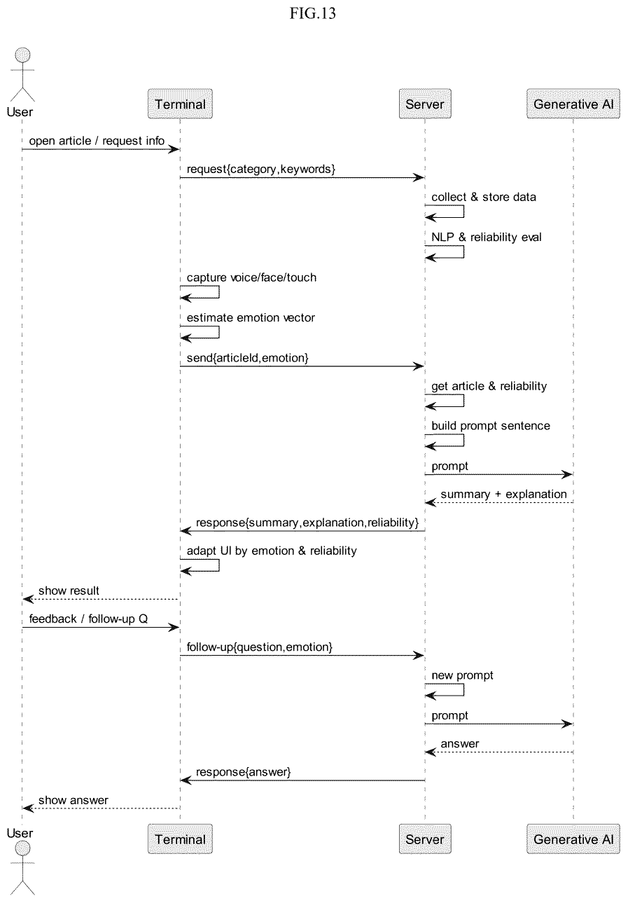

The following describes the processing flow using FIG. 13.

### Step 1:

Server receives an information request from the terminal and generates internal query parameters.

Server receives, as input, a request message from the terminal including at least a category (for example, “economy”), keywords (for example, “inflation”), a desired number of items, a time range, and a user identifier. Server parses the request using an application framework and validates the parameters (for example, checks that the requested number of items does not exceed a configured limit). Based on this input, server performs data processing that maps human-readable parameters into a structured internal query object, including a list of target source types (news, social media, blogs, forums), time windows, and ranking criteria. Server outputs this internal query object as a structured data record that will drive subsequent information collection.

### Step 2:

Server collects raw data from external information provision services and normalizes it into unified records.

Server takes the internal query object as input and determines a set of target endpoints (for example, news search URLs, social media API queries, blog and forum feeds). Server uses an HTTP client library to send network requests to these endpoints and receives HTML documents, JSON responses, and feed data as input streams. Server parses each HTML document with an HTML parser to extract titles, body texts, timestamps, and categories, and parses each JSON object to extract post texts, user handles, engagement counts, and IDs. From these heterogeneous inputs, server executes data transformations that map different field names and formats into a common schema (article_id, source_type, source_domain, title, body_text, publish_time, category, raw_metadata). Server outputs a collection of unified article records and stores them in a database.

### Step 3:

Server performs natural language processing on the collected text and generates tokens, keywords, and embeddings.

Server reads unified article records from the database as input, selecting those with a processing_status indicating that natural language processing has not yet been performed.

Server passes each body text to a morphological analysis engine, which outputs token sequences with part-of-speech tags. Server filters tokens to remove stopwords and non-content parts of speech, then computes TF-IDF scores using a numerical library that multiplies term-frequency matrices and inverse-document-frequency vectors. Server also encodes full texts and candidate phrases using a transformer-based language model to produce embedding vectors. From these inputs and operations, server outputs: (i) token lists with part-of-speech tags, (ii) ranked keyword lists, (iii) ranked keyphrase lists, and (iv) document embeddings, and writes these outputs to corresponding tables (article keywords, article_keyphrases, article_embeddings).

### Step 4:

Server constructs reliability feature vectors from NLP results, source attributes, and social signals.

Server uses as input the NLP outputs (keywords, keyphrases, embeddings), source attributes (source_type, source_domain, past reliability history, false information history), temporal attributes (publish_time, elapsed time), and social reaction indicators (emotion distributions and engagement metrics) stored in the database. Server encodes categorical variables into one-hot or index-based vectors and normalizes numerical variables using stored mean and variance parameters. Server concatenates these encoded values, along with similarity scores computed by measuring cosine similarity between an article's embedding and embeddings of articles from trusted sources, into a high-dimensional numeric array. The resulting data transformation is a deterministic mapping from heterogeneous fields to a fixed-length feature vector. Server outputs a reliability_feature_vector for each article and stores or passes it to the reliability model inference pipeline.

### Step 5:

Server evaluates reliability scores and classes using a trained machine learning model.

Server takes each reliability_feature_vector as input and feeds it into a trained reliability evaluation model implemented as a neural network or gradient boosting model. The model performs matrix multiplications and non-linear activations on the input features to compute intermediate hidden representations, then applies an output layer to produce a reliability_score and, optionally, class probabilities. Server maps the reliability_score to a reliability_class based on threshold comparison and applies rule-based post-processing by comparing the article embedding to embeddings of known false information items; if similarity exceeds a threshold, server subtracts a penalty from the reliability_score. From these computations, server outputs an updated reliability_score and reliability_class for each article and writes them back into the article records in the database.

### Step 6:

Terminal captures user interaction context and local emotion-related signals.

Terminal uses the current UI state as input, detecting when the user is viewing a news article or related content. Terminal activates listeners for microphone, camera, and touch events, subject to user permissions. Terminal captures audio segments and converts them into text using a speech recognition engine, generating transcribed text as output. Terminal simultaneously captures facial images via the camera and applies a face detection and landmark extraction model to obtain facial landmark coordinates. Terminal monitors touch gestures, recording sequences of scroll distances, velocities, and tap events over time. Using these raw signals as input, terminal computes derived features such as word-level sentiment indicators, facial expression scores, and behavioral metrics, which it outputs as structured feature vectors for each modality.

### Step 7:

Terminal estimates an emotion state vector from multi-modal features and sends it to the server.

Terminal uses the audio-derived, image-derived, and behavior-derived feature vectors as input to an on-device emotion fusion model implemented as a small neural network. The model performs weighted combinations and non-linear transformations of the feature values to infer intensities of multiple emotions (for example, anger, anxiety, joy, interest). Terminal outputs an emotion_state_vector, such as [anger=0.2, anxiety=0.7, joy=0.1, interest=0.6], and associates it with the currently displayed article_id and user identifier or session identifier.

Terminal packages these outputs into a JSON message and sends it via HTTPS to the server, thereby providing the server with compact, machine-readable emotion data instead of raw sensor data.

### Step 8:

Server retrieves article details and interprets the emotion state to determine generative AI behavior.

Server receives, as input, the message from the terminal containing article id, user identifier, and emotion_state_vector. Server queries the database for the corresponding article to load body_text, title, category, source attributes, reliability_score, and reliability_class. Server then interprets the emotion_state_vector by comparing each emotion intensity element against configured thresholds; for example, server marks user_is_anxious if the anxiety component exceeds a threshold, and user_is_angry if the anger component exceeds another threshold. From these inputs, server performs logical decision operations to select a prompt template type (for example, “anxious+medium reliability”, “angry+any reliability”, “high interest+high reliability”). Server outputs a template selection and a set of parameter values (reliability_score, reliability_class, category, flags indicating emotional conditions).

### Step 9:

Server constructs a prompt sentence for the generative AI model based on reliability and emotion.

Server uses the selected template and parameter values as input and generates a prompt sentence string via template rendering and concatenation operations. Server inserts the actual reliability_score and reliability_class values into the prompt, and appends explicit instructions that specify the desired output format (for example, numbered sections) and writing style (for example, neutral tone, avoidance of aggressive language). Server also embeds the full article body_text into the prompt as a content section following the instructions. This text concatenation and substitution process results in a complete prompt sentence, which server outputs as a single string ready to be sent to the generative AI model.

### Step 10:

Server invokes the generative AI model with the prompt sentence and receives generated text.

Server uses the constructed prompt sentence as input to a generative AI model, which may be hosted locally or accessed via a remote API. Server sends the prompt sentence along with generation parameters, such as maximum token count, temperature, and decoding method (for example, greedy or nucleus sampling). The generative AI model processes the prompt internally using a transformer architecture, applying attention mechanisms and token-by-token decoding to generate an output text. Server receives this generated text as output and then performs parsing operations, such as splitting by numbered sections or markers, to separate the summary part and the reliability explanation part. Server may apply additional filtering, for example scanning for prohibited terms or patterns. Server outputs a structured pair comprising a summary_sentence and a reliability_explanation_sentence.

### Step 11:

Server assembles a response package and sends it to the terminal.

Server takes as input the summary_sentence, reliability_explanation_sentence, reliability_score, reliability_class, and selected article metadata (for example, title and a truncated body text). Server creates a structured response object that includes these elements and may also include layout hints, such as a warning_level based on low reliability or a detail_level based on high user interest. The server serializes this object to JSON, which is output as a response message and transmitted to the terminal over the network.

### Step 12:

Terminal adapts the user interface layout based on reliability and emotion, and displays the results.

Terminal receives the response JSON from the server as input and deserializes it into internal objects representing the summary_sentence, reliability_explanation_sentence, reliability_score, reliability_class, and any layout hints. Terminal refers to the latest local copy of the emotion_state_vector and executes decision logic: for example, if reliability_class is “low” and the anxiety component is high, terminal chooses a “cautious layout” profile; if reliability_class is “high” and the interest component is high, terminal chooses an “exploratory layout” profile. Using the selected profile as input, terminal performs UI configuration operations that set the display order (for example, explanation first, then summary, then collapsed body), visual emphasis (font sizes, colors, icons), and visibility of interaction controls (for example, buttons for “show more” or “see related reliable sources”).

Terminal then renders the configured layout to the display as output, presenting the generated summary and explanation in a form adapted to both the evaluated reliability and the user's emotional state.

### Step 13:

User reviews the presented information, provides feedback, and optionally issues follow-up queries.

User receives, as input via visual perception, the terminal's display including the summary_sentence, reliability_explanation_sentence, reliability indicator, and optionally the article body text. User may tap feedback buttons such as “I understood” or “I am still anxious,” or may type or speak additional questions (for example, “Which parts are most uncertain?”). These user actions produce events and content that the terminal captures as input data. Terminal processes these inputs by updating its local emotion estimate and assembling a new request message containing the user's question and current context. Terminal outputs this new request to the server, which then re-enters the pipeline from Step 8 to construct a new prompt sentence and obtain a new response, thereby closing the feedback loop between user emotion, generative AI behavior, and reliability-aware information provision.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional security information processing systems typically separate external threat analysis from user interaction design and treat users as homogeneous endpoints. Existing architectures often collect threat intelligence from networks or external information sources, and may assess reliability of that intelligence, but they generally deliver static warnings and generic operation requests to users regardless of an individual user's emotional or cognitive state. As a result, conventional systems are prone to alert fatigue, user stress, mis-clicks on dangerous links, and other human errors that degrade the overall effectiveness of technical countermeasures.

Furthermore, traditional systems that evaluate reliability of threat information often rely on relatively simple rule-based logic or isolated machine learning components. These systems are not designed to jointly optimize (i) the machine-side decision of how to prioritize and respond to threats and (ii) the human-side delivery of explanations, in a closed feedback loop.

In addition, while generative AI models are increasingly used to generate explanatory text, their use is often ad hoc: prompt sentences are manually crafted, do not systematically incorporate threat confidence metrics, and do not adapt to dynamically inferred user states.

This leads to explanations that may be overly technical, unnecessarily alarming, or insufficiently precise, thereby increasing cognitive load on users and administrators.

From the perspective of computer technology, existing systems lack an integrated processing pipeline in which a processor (1) acquires and normalizes heterogeneous external information and network logs, (2) performs natural language processing to identify and classify security threats, (3) computes a quantitative threat reliability index using trained numerical models, (4) recognizes user emotional states from operation histories and biometric signals using time-series and image models, and (5) uses both the threat reliability index and the emotional state index to programmatically construct optimized prompt sentences to a generative AI model and to automatically or semi-automatically control concrete countermeasures. Absent such integration, the computer cannot autonomously tailor its generative output and control logic to reduce human error while preserving or enhancing security.

In addition, conventional architectures do not structure the data transformations and model invocations in a way that improves the functioning of the computer itself. Input and output flows among threat analytics, emotion recognition, and explanation generation are often loosely coupled, resulting in redundant processing, inconsistent data representations, and manual intervention in the decision loop. As a consequence, the computer system as a whole exhibits suboptimal resource usage and latency, and fails to provide consistent, context-aware responses under high load or evolving attack patterns.

Therefore, there is a need for a computer-implemented system that improves the way a processor acquires, normalizes, analyzes, and fuses external threat information and user state information, and that programmatically generates and uses prompt sentences for a generative AI model to drive security countermeasures. Such a system should provide improved processing pipelines and control flows that enable the computer to more accurately prioritize threats, adapt communication to user emotional conditions, and automatically enforce technical defenses, thereby improving the overall reliability, robustness, and usability of computer security operations.

The specific processing by the specific processing unit 290 of the data processing device 12 in Application Example 2 is realized by the following means.

The present invention provides a server comprising a processor and a storage unit, the processor being configured to (i) acquire, via a communication line, external information and communication records from at least one external information source and at least one communication device, normalize the acquired external information and communication records into a structured format, and store the normalized external information and communication records in the storage unit as collected data; (ii) analyze text data included in the collected data by performing character string segmentation processing, lexical classification processing, and semantic analysis processing, extract a text document including a term related to information security, and estimate a type and a feature of a security threat on the basis of the text data and the communication records as natural language processing; (iii) input, into a trained numerical computation model, attribute values including a type of the external information source, a past attack case, an abnormality degree based on the communication records, and a past reliability evaluation as feature amounts, calculate, for each security threat, a threat reliability index indicating an occurrence possibility of the security threat, and classify the security threat into a plurality of priority levels on the basis of the threat reliability index as reliability evaluation; (iv) acquire at least one of operation history information of a user and biometric information of the user from a terminal, input a time-series pattern and an expression feature contained in the operation history information and the biometric information into a trained numerical computation model, estimate, as an emotion state index, at least a stress degree, an anxiety degree, an attention decrease degree, and a fatigue degree of the user, and record the emotion state index in the storage unit as emotion recognition; (v) refer to the threat reliability index and the emotion state index, select a template from a plurality of templates stored in the storage unit, embed technical information regarding the security threat and attribute information regarding the user into the selected template to construct a prompt sentence as a generation input sentence, transmit the prompt sentence to a generative artificial intelligence model via an application programming interface, and acquire a response text generated by the generative artificial intelligence model as generative AI cooperation; and (vi) control, on the basis of the response text and the threat reliability index, at least one of a setting change of a network device, a setting change of an information processing device, isolation of an electronic message, and display of warning information in an automatic or semi-automatic manner, and present the response text to at least one of the user and an administrator as information provision. This enables the computer system to improve internal data processing and control flows by tightly integrating threat analysis, reliability scoring, emotion recognition, and generative AI-based explanation generation, thereby allowing the processor to dynamically tailor prompt sentences and automated countermeasures to both machine-detected threat conditions and user emotional states, reducing human error, increasing the effectiveness of security defenses, and enhancing the technical performance and robustness of the overall security processing architecture.

The term “communication line” refers to a logical or physical collection of wired and/or wireless communication paths and intermediary devices that enable exchange of digital data between the server, external information sources, communication devices, and terminals.

The term “external information source” refers to an information providing entity, independent of the system, that publishes or distributes digital content including text data or structured data, such as news distribution services, information providing services, electronic bulletin boards, or social information sharing services.

The term “communication device” refers to a network device or information processing device that sends or receives communication packets on a communication line and outputs communication records, including a router, a switching device, a firewall device, or an intrusion detection or prevention device.

The term “external information” refers to digital content obtained from an external information source, including at least text data and structured data that may contain information security related terms or threat intelligence.

The term “communication record” refers to log data representing communication activities, including at least a source identifier, a destination identifier, communication control information such as protocol and port, volume information, and time information.

The term “structured format” refers to a data representation in which items of information are arranged according to a predefined schema or data model, including formats such as tables, records, documents, or objects that can be stored and processed in a storage unit.

The term “storage unit” refers to a hardware or software component including a memory device or a mass storage device that stores collected data, intermediate processing results, templates, model parameters, and indexes, and that is accessible by the processor.

The term “collected data” refers to normalized data stored in the storage unit, the data including at least external information and communication records acquired from external information sources and communication devices.

The term “text data” refers to information expressed in a natural language character sequence, including at least article texts, posts, messages, titles, and other textual fields obtained from external information sources.

The term “character string segmentation processing” refers to processing that divides a text data sequence into smaller units such as words, subwords, or tokens according to language-dependent rules or models.

The term “lexical classification processing” refers to processing that assigns categories such as part-of-speech tags or other lexical attributes to tokens obtained by character string segmentation.

The term “semantic analysis processing” refers to computational processing that derives meaning-related information from text data, including at least extraction of relevant terms, estimation of semantic relations, and identification of sentence-level or document-level topics.

The term “term related to information security” refers to a word or phrase indicating a security concept, including terms associated with malware, unauthorized access, vulnerability, denial of service, phishing, data leakage, or other security threats or countermeasures.

The term “security threat” refers to an event, condition, or activity that may cause harm or disadvantage to an information system or information asset, including malware infection, unauthorized access, service disruption, fraudulent communication, or information leakage.

The term “trained numerical computation model” refers to a statistical or mathematical model implemented in software or hardware, the model having been trained using past data so as to perform inference tasks such as classification, regression, or prediction based on numerical feature amounts.

The term “attribute value” refers to a numerical or categorical value that represents a property of data, including at least a type of external information source, an indicator of a past attack case, an abnormality degree derived from communication records, and a past reliability evaluation.

The term “feature amount” refers to a numerical representation derived from raw data, suitable as input to a numerical computation model, and including at least attribute values and statistical values computed from text data or communication records.

The term “past attack case” refers to information stored in the system indicating that a similar security threat has occurred before, including identifiers of threat type, frequency, and actual incident outcomes.

The term “abnormality degree” refers to a quantitative indicator of deviation of communication records from a learned or predefined normal communication pattern, computed by statistical analysis or anomaly detection algorithms.

The term “past reliability evaluation” refers to a previously computed measure of trustworthiness for information items or sources, stored in the system and used as part of feature amounts in reliability evaluation.

The term “threat reliability index” refers to a numerical value that indicates, for each security threat, an estimated possibility that the threat is true or will actually occur, and that is computed by a trained numerical computation model based on feature amounts.

The term “priority level” refers to a classification category that indicates relative importance or urgency of addressing a security threat, the category being determined based on the threat reliability index according to predefined thresholds or rules.

The term “operation history information” refers to recorded information about a user's interactions with a terminal, including at least key input events, pointing device operations, window focus changes, and responses to warning displays, with associated time information.

The term “biometric information” refers to information derived from physical, physiological, or behavioral characteristics of a user, including at least face image data, facial expression data, heart rate, or other measurable signals indicative of the user's state.

The term “terminal” refers to a client-side information processing device operated by a user, including at least a personal computer, a portable information terminal, a smartphone, or a tablet device, that is capable of communicating with the server via a communication line.

The term “time-series pattern” refers to a sequence of numerical or categorical values ordered in time and derived from operation history information or biometric information, representing temporal variation in user behavior or physiological signals.

The term “expression feature” refers to a numerical representation of a user's facial expression or other observable behavior, extracted from biometric information such as face images by image processing or pattern recognition techniques.

The term “emotion state index” refers to a set of numerical indicators representing psychological or emotional conditions of a user, including at least a stress degree, an anxiety degree, an attention decrease degree, and a fatigue degree.

The term “stress degree” refers to a numerical indicator that expresses an estimated level of stress of a user based on operation history information and biometric information.

The term “anxiety degree” refers to a numerical indicator that expresses an estimated level of anxiety of a user based on operation history information and biometric information.

The term “attention decrease degree” refers to a numerical indicator that expresses an estimated extent of reduced attention or concentration of a user based on operation history information and biometric information.

The term “fatigue degree” refers to a numerical indicator that expresses an estimated level of fatigue of a user based on operation history information and biometric information.

The term “template” refers to a predefined data structure or text pattern that includes fixed text segments and placeholder fields, the placeholder fields being replaced with technical information and user attribute information to construct a prompt sentence.

The term “technical information regarding the security threat” refers to structured or unstructured information describing characteristics of a detected or estimated security threat, including at least threat type, network identifiers, related resources, and summarized historical cases.

The term “attribute information regarding the user” refers to information associated with a user that is relevant to tailoring explanations or control decisions, including at least an identifier of the user, a role of the user, and the user's emotion state index.

The term “prompt sentence” refers to a natural language sentence or sequence of sentences constructed as a generation input to a generative artificial intelligence model, specifying a role, context, and output constraints of the model.

The term “generation input sentence” refers to a prompt sentence used as an input to guide a generative artificial intelligence model to produce a desired response text.

The term “generative artificial intelligence model” refers to a trained model that, in response to an input including a prompt sentence, generates new text as output, the model including at least a large language model or other text generation architecture.

The term “application programming interface” refers to a defined interface that enables programmatic communication between the server and an external or internal service, including at least an interface for transmitting a prompt sentence to a generative artificial intelligence model and receiving a response text.

The term “response text” refers to generated text output produced by a generative artificial intelligence model in response to a prompt sentence, including at least explanations, recommendations, or guidance related to a security threat.

The term “network device” refers to a device that controls or forwards communication packets on a communication line, including at least a router, a switching device, a firewall device, or an intrusion detection or prevention device.

The term “information processing device” refers to a device that includes a processor, a storage unit, and a communication function, and that performs input, output, and processing of information, including at least a server device and a client device.

The term “electronic message” refers to a digital communication unit transmitted over a communication network, including at least an electronic mail message or other message containing text, attachments, or embedded links.

The term “isolation of an electronic message” refers to processing that moves or stores an electronic message into a restricted area separate from a normal reception area so that direct viewing or manipulation by a user is limited or prevented.

The term “warning information” refers to information presented to a user or an administrator to indicate the presence, risk, or status of a security threat, including at least warning messages, alerts, or explanations.

The term “automatic or semi-automatic manner” refers to a mode of control in which at least one part of a security countermeasure is executed by the system without manual command, optionally allowing user or administrator confirmation or override for certain actions.

The term “administrator” refers to a user who has responsibility and authority for managing information systems, security settings, or network devices, and who receives technical information and recommendations from the system.

In the following embodiments, server, terminal, and user denote logical roles implemented on one or more physical machines. One skilled in the art can modify hardware and software components without departing from the scope of the invention.

Server is implemented as an information processing device including at least one general-purpose processor (CPU), a main memory, a non-volatile storage unit such as a semiconductor storage device or a magnetic disk device, and a network interface. Server executes an operating system such as a server-oriented operating system, and server executes application programs implementing the functional units described in the claims. Server may also include a hardware accelerator such as a graphics processing unit (GPU) or a tensor processing unit (TPU) used for numerical computation in neural network models.

Terminal is implemented as a client-side information processing device including at least one processor, a memory, a storage unit, an input device such as a keyboard and a pointing device, a display device, and at least one communication interface. Terminal executes a client operating system such as a desktop operating system or a mobile operating system, and terminal executes a web browser or a dedicated client application that communicates with server.

User operates terminal to view electronic messages, access network resources, and respond to security notifications presented by terminal. User may also be an administrator who accesses a management console provided by server through terminal.

Server uses a software stack including a general-purpose programming language such as a script language, a relational database management system such as a relational database server, a search system such as a full-text search engine, and libraries for numerical computation and machine learning. For example, server uses libraries for HTTP communication, document parsing, natural language processing, image processing, and neural network computation.

Server stores models, templates, and configuration data in the storage unit and loads them into main memory as needed.

Server acquires external information from external information sources by using the network interface and an HTTP client library. Server sends a request signal to each external information source at predetermined intervals or in response to a trigger. Server receives response data including at least one of HTML documents and structured data such as JSON documents. Server parses each HTML document to extract article titles, body texts, publication times, and identifiers by traversing the document structure and extracting node contents. Server parses each structured data document by reading fields corresponding to textual content, metadata, and identifiers.

Server acquires communication records from communication devices by using a protocol such as syslog, file transfer, or an application programming interface provided by the communication device. Server receives records including at least a source identifier, a destination identifier, communication control information such as protocol and port, volume information such as number of bytes, and time information. Server converts the received records into a structured format, assigns field names, and stores them in the storage unit, for example as indexed log entries in a search system.

Server normalizes both the external information and the communication records into a common internal representation. Server assigns a unique identifier to each external information item and to each communication record, associates a source type label, and stores the normalized data in a relational table or document store. By using this representation, server avoids repeated parsing of raw formats and reduces processing load in later stages.

Server performs natural language processing on text data included in the collected data.

Server loads a natural language processing pipeline including character string segmentation, lexical classification, and semantic analysis. Server first applies character string segmentation to divide text into tokens such as words or subwords. In one embodiment, server uses a dictionary-based or statistical tokenizer adapted to the language of the text to generate token boundaries. Server then applies lexical classification to each token, assigning part-of-speech tags or other lexical categories by using a trained tagging model such as a conditional random field or a neural tagger.

Server performs semantic analysis by computing document embeddings. In one embodiment, server uses a transformer-based neural network model that has been pre-trained on a large corpus. Server converts token sequences into integer indices, feeds the indices into the transformer, and obtains embeddings from a designated output position or from an aggregation layer. Server uses these embeddings to represent semantic features of the text.

Server derives additional semantic features by detecting the presence of terms related to information security. Server compares tokens or n-grams in the text with a security dictionary containing terms and phrases associated with malware, vulnerabilities, unauthorized access, and other threat concepts. Server flags sentences or documents that contain such terms and assigns preliminary labels such as “security-related” or “non-security-related.” Server estimates a type and a feature of a security threat by inputting the document embedding and auxiliary features into a classification model. In one embodiment, server uses a feed-forward neural network comprising multiple fully connected layers with non-linear activation functions, such as rectified linear units, and an output layer with a softmax or sigmoid function. Server provides as input features the document embedding, binary flags for security terms, and source-type indicators. Server obtains as output a probability distribution over threat categories such as phishing, malware, denial-of-service, or other categories. Server records the predicted category, associated probabilities, and an identifier for the text in the storage unit.

Server evaluates reliability of each detected or estimated security threat by using a trained numerical computation model. Server constructs feature amounts for each threat instance by combining attribute values including the type of external information source, indicators of past attack cases, abnormality degrees derived from communication records, and past reliability evaluations. For example, server computes a source reliability score by mapping the source type (such as public agency, security organization, or anonymous forum) to a numerical weight. Server computes an abnormality degree by aggregating communication records related to the threat (for example, communications contacting a suspicious domain) and applying anomaly detection algorithms to traffic statistics.

In one embodiment, server trains a multilayer neural network for reliability evaluation. Server defines an input layer matching the dimension of the feature amounts, one or more hidden layers with non-linear activation functions, and an output layer with a sigmoid activation that generates a value between zero and one. Server trains this model offline using labeled historical data where threats are annotated as realized incidents or false alarms. Server uses a loss function such as binary cross-entropy, applies regularization, and updates model parameters by gradient-based optimization such as stochastic gradient descent or adaptive moment estimation. Server may use data augmentation techniques such as sampling different time windows or mixing features from similar threats to increase robustness.

Server loads the trained model into memory at runtime and inputs feature amounts for current threats to obtain a threat reliability index for each threat. Server classifies each threat into a priority level (for example, high, medium, or low) by comparing the index against threshold values stored in configuration data. This specific use of numerical thresholds and learned feature combinations improves precision compared to simple rule-based scoring and reduces false positives, which in turn reduces unnecessary traffic and storage load for subsequent handling.

Server recognizes an emotional state of user by analyzing operation history information and biometric information received from terminal. Terminal monitors user input events by registering with the operating system event interface for keyboard and pointing device signals. Terminal records the time of each event and may aggregate events into fixed time windows, computing statistics such as keypress rate, frequency of correction keys, reaction time to pop-up dialogs, and pointing device click rate.

Terminal, with consent of user, acquires biometric information such as face images and heart rate signals. Terminal uses an image processing library to detect a face region in a captured image frame. Terminal crops and resizes the face region to reduce resolution and compresses the image. Terminal acquires heart rate from a connected wearable sensor using a device-specific application programming interface and timestamps each measurement.

Terminal sends operation statistics and biometric data as a structured bundle to server through a secure communication channel. Terminal may discard raw frames after cropping and encoding to reduce local storage usage and privacy risk.

Server receives this data and passes it to an emotion recognition module. Server uses a facial expression recognition network, for example a convolutional neural network with multiple convolution and pooling layers followed by fully connected layers, pre-trained on labeled facial expression datasets. Server inputs the cropped face images to this network to obtain probabilities for emotions such as joy, anger, sadness, fear, surprise, and neutral.

Server also uses a time-series model such as a recurrent neural network, for example a long short-term memory network, to process operation statistics and heart rate data. Server forms a sequence of feature vectors where each vector contains aggregated operation metrics and biometric signals for a time step. Server inputs the sequence to the recurrent network, which outputs state vectors across time and a final vector that encodes temporal patterns suggestive of stress or fatigue. Server maps the final vector to scalar values representing stress degree, anxiety degree, attention decrease degree, and fatigue degree through a fully connected output layer with appropriate activation functions.

Server fuses the facial expression probabilities with the time-series outputs by using either a separate neural network or a weighted averaging rule. For example, server may use a small fusion network that takes as input the concatenated vector of expression probabilities and time-series output and produces final emotion state indices. Server stores the emotion state indices, along with user identifiers and time windows, in the storage unit.

By structuring emotion recognition in this way, server can compute stable numerical emotion indicators without continuous manual observation, and server can adaptively sample inputs and adjust model complexity based on resource availability, which improves computational efficiency and makes the system more scalable.

Server uses both the threat reliability index and the emotion state index to construct a prompt sentence for a generative AI model. Server stores multiple prompt templates in the storage unit, each template specifying a role, an output style, and structural constraints for the generative AI model. Templates may be defined for cases such as highly reliable phishing threats addressed to anxious users, lower-reliability threats addressed to neutral users, and technical summaries addressed to administrators.

Server selects a template according to selection rules. For example, when the threat reliability index exceeds a first threshold and at least one of the stress degree or the anxiety degree exceeds a second threshold, server selects a template that instructs a calm and reassuring explanation. When the threat reliability index exceeds a further threshold and attention decrease degree is high, server may select a template that emphasizes automatic countermeasures and minimal required user interaction.

Server embeds technical information regarding the security threat and attribute information regarding user into placeholder fields in the selected template. Technical information includes data such as the email subject and body for a suspected phishing email, a list of suspicious URLs, a relevant threat reliability index, and summarized past incidents related to the same domain. Attribute information includes data such as user role, current emotion state indices, and whether user is a general employee or an administrator.

Server constructs a complete prompt sentence as a contiguous text sequence, specifying the context and output constraints for the generative AI model. For example, server may generate a prompt sentence for an anxious end user as follows:
“You are a security support staff member of a company. The target user is currently estimated to be under high stress and anxiety. The following email is suspected to be a phishing attack.
--- Email body ---
[Full email text]
1) Without blaming the user, explain in a calm tone,
2) Describe at most three key points that indicate why this email is dangerous, in concise bullet points, and
3) End with a reassuring sentence that says, in effect, ‘It is safe to delete this email. If you are unsure, please contact the security team.’
Please write the explanation in Japanese.”
Server may generate another prompt sentence for an administrator, for example:
“You are a security analyst for an enterprise network. Below is technical information about a phishing attack detected in our network.
-- Technical information --
Source IP: [IP address]
Detected URLs: [URL list]
Threat reliability score: [score]
Similar past incidents: [summary]
---------------
1) List three actions that should be taken immediately, in bullet points,
2) Then briefly explain the reasons and background for each action, and
3) Finally, propose a concrete example of a firewall rule that can be applied automatically. Write the answer in Japanese for a technical audience.”

Server sends the constructed prompt sentence to a generative AI model via an application programming interface. In one embodiment, the generative AI model is a large language model hosted externally. Server issues a request including the prompt text and parameters such as maximum token count and temperature. Server receives a response containing the generated text.

Server normalizes the response text by removing extraneous markers and ensuring consistent encoding. Server may parse structural cues such as bullet points or numbering to separate explanation segments, recommended countermeasures, and reassurance phrases. Server stores this text in the storage unit and forwards the relevant parts to terminal for display.

Server also uses the response text to guide control of network devices and information processing devices. When the threat reliability index is high and automated countermeasures are permitted by configuration, server generates configuration commands for network devices, such as firewall rules to block traffic from specific source identifiers or to deny connections to certain domains. Server calls management interfaces of the devices with these commands. Server also sends commands to email handling systems to move suspicious messages to a quarantine area. Server logs which rules were applied, which messages were isolated, and success or error codes from devices.

By integrating generative AI model output into device control in this structured way, server reduces manual workload on administrators and decreases reaction time to emerging threats.

At the same time, by using threat reliability indices and emotion state indices as explicit inputs to the prompt generation process, server reduces over-blocking and unnecessary user disruption, thus improving both security effectiveness and system usability.

Terminal presents the response text to user or administrator according to the emotion state index. For an anxious user, terminal chooses a visual theme that avoids bright colors or alarming icons and displays brief, structured explanations. Terminal shows buttons such as “Delete this email,” “Review later,” and “Contact security team.” Terminal sends button selections back to server, which uses them both to execute corresponding actions and to further update behavioral models.

For administrators, terminal displays a management console with lists of threats, their reliability indices, and recommended actions. Terminal provides controls such as “Apply recommended firewall rule” or “Approve quarantine for listed messages.” Administrator actions are transmitted to server as structured commands, which server translates into configuration operations on devices.

The described embodiments improve computer technology in multiple ways. By normalizing heterogeneous text and log data into structured formats and by using specific neural architectures and learned feature combinations for reliability evaluation and emotion recognition, server achieves higher accuracy and reduces false alarms compared to rule-based or manual techniques. This reduced false-positive rate leads to fewer unnecessary device configuration changes and fewer irrelevant alerts presented to users, which directly lowers communication and processing load.

By using emotion state indices to control prompt selection and device actions, server changes how computational resources are used. In situations where user attention is low, server increases the degree of automation, thereby reducing response latency and avoiding reliance on delayed human action. In situations where user anxiety is high, server modifies prompt sentences to avoid information overload and to present minimal but sufficient guidance, which improves the probability that user will perform the right action and reduces the number of subsequent corrective operations required from server and devices.

Furthermore, by defining specific data flows—external information to document embeddings, embeddings and log features to reliability indices, operation and biometric sequences to emotion indices, indices to prompt sentence construction, and prompt sentences to generative output and device control—the system organizes processing into a pipeline that minimizes redundant computation. For example, document embeddings computed for classification are reused as features for reliability evaluation, and emotion state indices computed once per interval are reused for multiple threat events within that interval. This reuse reduces repeated neural network evaluations and improves overall throughput.

In alternative embodiments, server may replace some neural network components with other numerical models such as gradient boosting models or support vector machines for certain feature spaces. Server may also adjust network architectures, for example by using deeper convolutional layers for high-resolution face images or by using attention-based time-series models for complex user interaction patterns. Server may deploy models on accelerators for heavy loads or on central processing units alone for low-volume installations.

Server and terminal may be implemented as separate physical devices or as virtual instances on a shared physical hardware platform. The functions described as being performed by server may be distributed across multiple machines, and some components such as emotion recognition may be offloaded to terminal when privacy or latency requirements so dictate.

In each embodiment, the essential characteristic is that server uses specific trained numerical models, defined feature amounts, structured templates, and explicit control rules to link threat analysis, emotion recognition, prompt sentence generation for a generative AI model, and automatic or semi-automatic control of network devices and information processing devices.

This linkage causes the computer system to behave in a way that does not simply automate human judgment, but instead uses model-based, non-intuitive combinations of features to improve speed, precision, and robustness of security operations, thereby improving the operation of the computer itself.

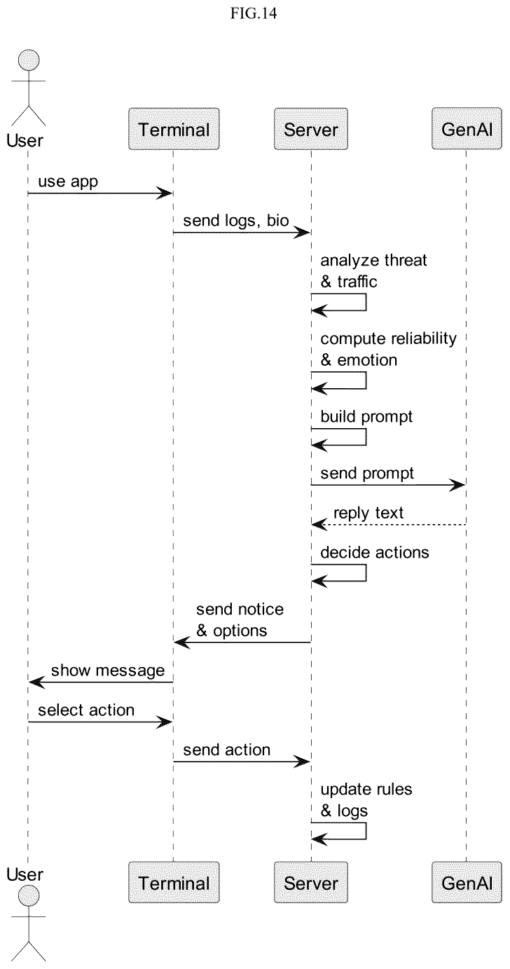

The following describes the processing flow using FIG. 14.

### Step 1:

Server acquires and normalizes external information and communication records.

Server receives, as input, response data from external information sources (HTML pages and structured JSON documents) and raw communication logs from communication devices (records including source identifiers, destination identifiers, protocol identifiers, port numbers, byte counts, and timestamps). Server sends HTTP or HTTPS requests to external information sources using an HTTP client library and receives the response bodies. Server parses each HTML document to extract fields such as title, body text, publication time, and source identifier, and parses each JSON document to extract text fields and metadata fields according to a predefined schema. Server also receives communication log entries via a logging protocol or an application programming interface, and server maps raw log fields to normalized field names. Based on these inputs, server converts texts and logs into structured records, assigns unique identifiers and source type labels, and outputs normalized external information records and normalized communication records stored in a storage unit.

### Step 2:

Server performs natural language preprocessing on collected text data.

Server takes, as input, normalized external information records that contain text fields such as titles, body texts, and comments. Server applies character string segmentation to each text, generating a sequence of tokens by using a tokenizer that divides the text into word or subword units. Server then performs lexical classification by assigning part-of-speech tags or other lexical categories to each token using a tagging model or lexicon. Server further applies basic semantic analysis, such as sentence splitting and detection of information security related terms, by matching tokens and token sequences against a security vocabulary. Using these operations, server transforms raw text fields into token sequences, tagged token lists, and sentence-level annotations, and outputs preprocessed text objects that include tokenized text, lexical tags, and flags indicating the presence of security-related terms.

### Step 3:

Server computes document embeddings and estimates threat categories.

Server receives, as input, preprocessed text objects that include token sequences and lexical tags. Server converts each token sequence into numerical indices using a token-to-index mapping, and server feeds the indices into a trained language representation model, such as a transformer-based network residing in memory. The model performs internal matrix multiplications and non-linear transformations, producing a dense embedding vector for each document. Server collects these embedding vectors and concatenates them with auxiliary features such as source type indicators and security-term flags. Server then inputs the combined feature vectors into a classification network that computes, via weighted sums and activation functions, a probability distribution over predefined threat categories such as phishing, malware, and non-security. Based on this computation, server outputs, for each document, a predicted threat category, category probabilities, and a reference to the associated embedding vector, and stores this output in a threat candidate table.

### Step 4:

Server aggregates communication records and computes abnormality degrees.

Server takes, as input, normalized communication records containing identifiers, protocol data, and timestamps. Server groups records according to keys such as source identifier, destination identifier, port, and time window. For each group, server calculates statistics including connection count, total bytes transferred, average bytes per connection, and connection frequency, using arithmetic operations over the grouped records. Server forms a numerical feature vector from these statistics for each group and feeds the vectors into an anomaly detection model residing in memory. The model applies its learned parameters to compute an abnormality score, for example by comparing each feature vector to a distribution of normal patterns. Server evaluates the scores against a threshold and marks groups exceeding the threshold as anomalous. Server outputs anomalous traffic candidates with their abnormality degrees and related identifiers and stores them in an anomaly table.

### Step 5:

Server evaluates threat reliability using trained numerical models.

Server receives, as input, threat candidate records from the document classification output and anomalous traffic candidates with abnormality degrees from the anomaly table. Server constructs a feature amount vector for each threat instance by combining attributes such as source type, historical occurrence counts, historical incident confirmation ratio, and recent abnormality degrees from related communication records. Server loads a trained reliability evaluation model, which is a multi-layer neural network encoded in numerical parameters, and inputs the feature amount vector into the model. The model performs layered matrix multiplications and applies activation functions such as rectified linear units and a final sigmoid, generating a threat reliability index between zero and one. Based on this index, server compares against predefined thresholds and classifies the threat as high, medium, or low priority. Server outputs the threat reliability index and the assigned priority level, and records them in a threat management table.

### Step 6:

Terminal collects user operation history information.

Terminal receives, as input, low-level interaction events from the operating system, including keypress events, key release events, pointer movements, pointer clicks, window focus changes, and button activations. Terminal registers event listeners with the operating system and records each event with its type and timestamp. Over fixed-length time windows, terminal aggregates the raw event stream by counting keypresses, counting correction key usage, computing average reaction time to dialog boxes, and computing pointer click rate.

Terminal performs basic numerical calculations such as sums, differences, and averages on the timestamps and event counts to derive these statistics. Terminal outputs aggregated operation history information as structured records containing time window identifiers and per-metric values, and stores them locally until transmission to server.

### Step 7:

Terminal acquires biometric information and prepares user-state packets.

Terminal receives, as input, image frames from an imaging device and physiological measurements from a wearable sensor. Terminal uses an image processing library to detect a face region inside each frame by applying operations such as edge detection and classifier-based bounding box identification. Terminal crops and resizes the detected face region to a lower resolution and encodes the image to reduce data size. Terminal also reads heart rate or similar measurements from the wearable interface and associates each measurement with a timestamp. Terminal bundles the aggregated operation history information from Step 6 together with encoded face images and physiological values into a structured data object, including user identifier and time window identifiers. Terminal outputs this user-state packet and transmits it over a secure channel to server.

### Step 8:

Server estimates emotion state indices from user-state packets.

Server takes, as input, user-state packets containing operation history statistics, encoded face images, and physiological measurements. Server applies a facial expression recognition network to each face image by decoding the image, normalizing pixel values, and feeding the resulting tensor into a convolutional network that computes intermediate feature maps and produces probabilities for predefined expression categories. Server aggregates probabilities for each expression category across images in the same time window to derive an average expression profile. Server then assembles a time-series input for each user by ordering operation statistics and physiological values by timestamp, and feeds this sequence into a recurrent neural network, which updates internal state vectors at each time step and ultimately outputs summary vectors representing temporal patterns. Server maps these summary vectors to scalar degrees of stress, anxiety, attention decrease, and fatigue by applying linear transformations and activation functions. Server combines the expression profile with these degrees using either a small fusion network or a deterministic weighting rule, resulting in final emotion state indices. Server outputs the emotion state indices and records them along with user identifiers and time windows in an emotion-state table.

### Step 9:

Server selects a template and constructs a prompt sentence for the generative AI model.

Server receives, as input, threat records from the threat management table that include threat type, threat reliability index, and associated resource identifiers, and emotion state indices from the emotion-state table for the relevant user. Server evaluates conditions such as whether the threat reliability index exceeds a first threshold and whether one or more of stress degree or anxiety degree exceeds a second threshold. Based on these conditions, server selects a template from a stored template set, for example choosing a “reassuring explanation for high-stress user” template or a “technical summary for administrator” template. Server retrieves technical information related to the threat, such as the full suspected email body, suspicious URLs, and summarized past incidents, and retrieves attribute information about the user, such as role and current emotion indices. Server replaces placeholder tokens in the template with these values, concatenates text fragments, and ensures that required instructions to the generative AI model are present, including role specification, constraints on style, and required output format. Server outputs a fully constructed prompt sentence text and stores it temporarily for transmission.

### Step 10:

Server invokes the generative AI model and processes the response text.

Server takes, as input, the constructed prompt sentence from Step 9 and parameters such as maximum output length and randomness controls. Server packages the prompt sentence in a request format required by the generative AI model's application programming interface and sends this request over a network connection to a generative AI endpoint. Server waits for and receives a response containing generated text. Server extracts the response text from the response object, removes extraneous markers such as leading labels or repeated instructions by scanning for known patterns, and normalizes line breaks and whitespace. Server may apply simple parsing rules to identify bullet points, headings, or concluding phrases inside the response text. Server outputs a cleaned and optionally segmented response text and stores it in association with the triggering threat and user identifiers.

### Step 11:

Server controls security countermeasures and prepares notification content.

Server receives, as input, the threat reliability index and priority level for a given threat, the emotion state indices for the target user, and the cleaned response text from the generative AI model. Server evaluates policy rules that map combinations of threat reliability and emotion states to specific actions, such as automatic blocking or user-guided confirmation. When the rules indicate automatic action, server generates configuration commands for network devices, for example assembling a firewall rule to block traffic from a specified source identifier or to deny connections to a list of domains. Server also generates control commands for information processing devices, such as instructions to move specific electronic messages into a quarantine storage area. Server sends these commands to the respective devices via management interfaces and logs return codes. In parallel, server constructs notification messages for terminal by combining titles, explanatory text derived from the response text, and action labels such as “Delete,” “Review later,” or “Contact security team.” Server outputs device control commands to network and email systems, and outputs notification message objects to be sent to terminal.

### Step 12:

Terminal displays notifications and collects user actions.

Terminal receives, as input, notification message objects that contain titles, explanatory texts, and button definitions, along with identifiers linking the notification to specific threats.

Terminal may request or receive emotion state indices for the user and selects a user interface theme accordingly, for example reducing visual intensity for high-stress states. Terminal renders the explanatory text, including structured bullet points and concluding reassurance sentences, in a pop-up window or a dedicated panel. Terminal displays buttons mapped to actions such as deleting a message, postponing review, or contacting support. When user interacts with the notifications by clicking a button or closing the window, terminal records the action, the time, and the associated notification identifier. Terminal outputs user action events as structured data packets and sends them back to server for further processing and for updating operation history information.

### Step 13:

User interprets explanations and initiates security-relevant operations.

User receives, as input, the explanatory text and control options presented on terminal. User reads the generated explanation regarding why a message or activity is dangerous, including listed key points and the reassurance that safe deletion is allowed or that assistance is available. Based on this input, user chooses an action such as confirming deletion of an email, avoiding a suspicious link, requesting help, or approving a recommended device configuration when user acts as an administrator. User's decisions, manifested as button clicks or text input in a chat interface, form behavioral outputs that terminal captures and sends to server. These outputs influence both immediate system behavior, such as performing a delete operation or applying a configuration rule, and subsequent model inputs, as they are incorporated into updated operation history information and may affect future emotion state estimation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

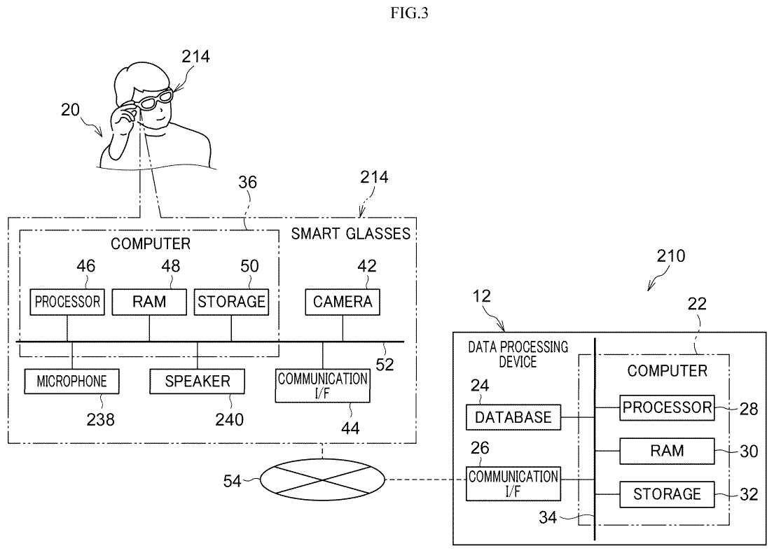

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

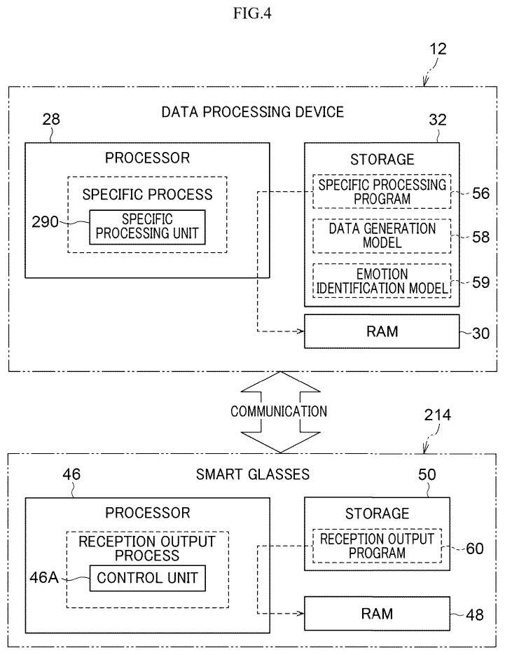

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

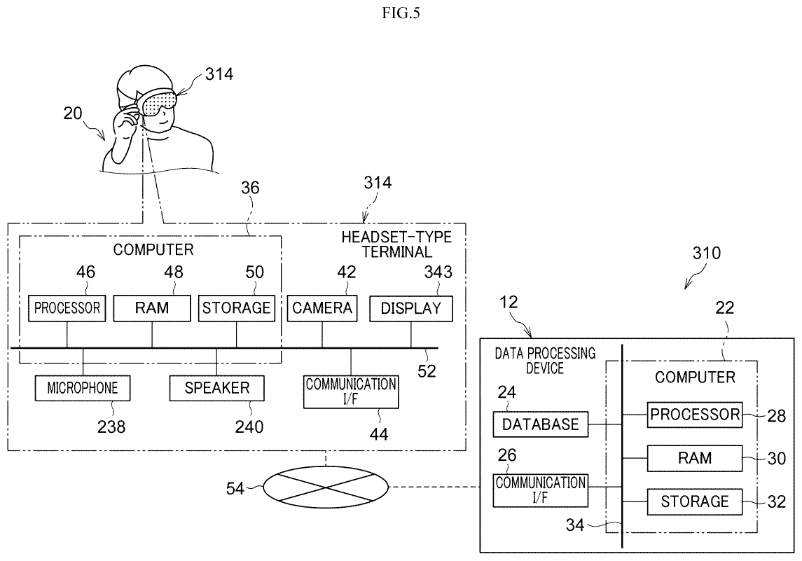

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

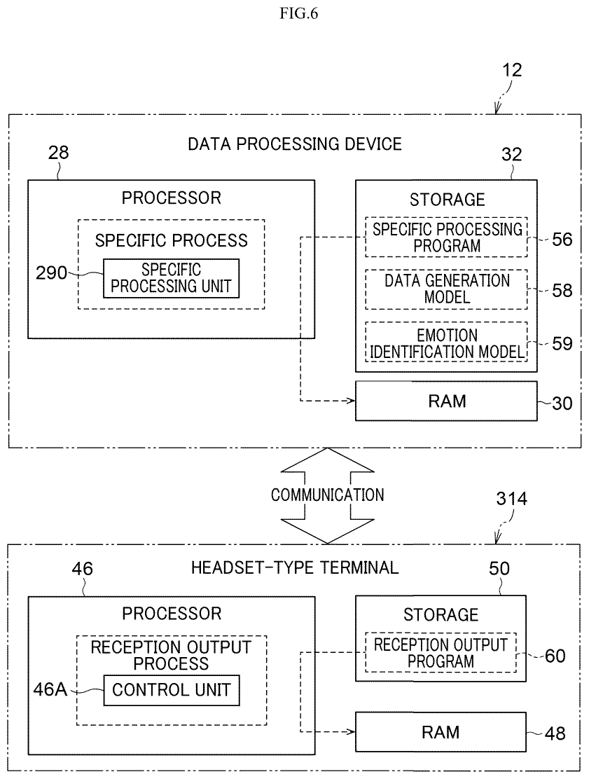

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

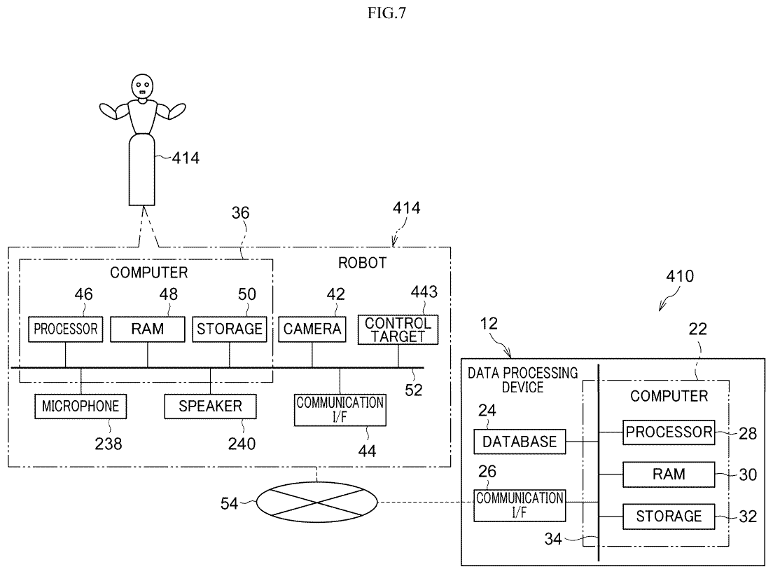

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

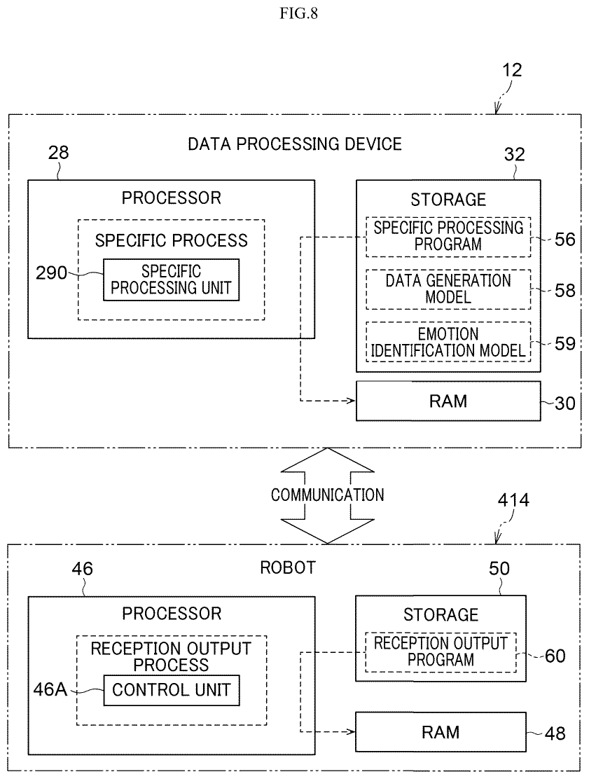

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

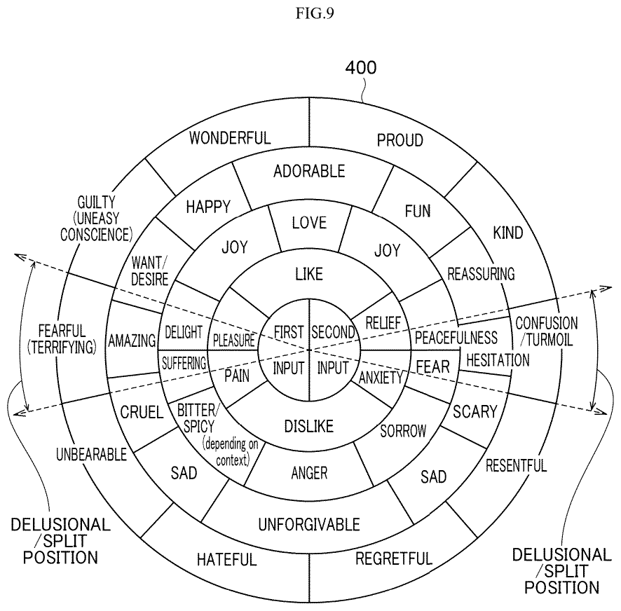

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

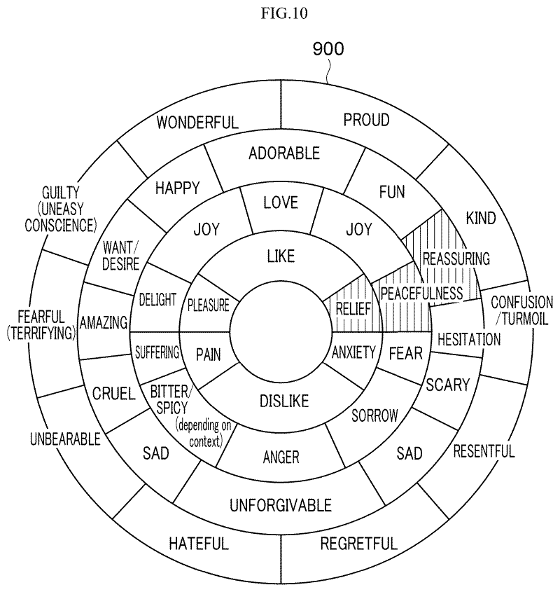

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, via a communication network, document data and associated metadata from a plurality of information sources, assign acquisition time information and source identification information to the acquired document data, and store the document data, the acquisition time information, and the source identification information in a storage device,
perform preprocessing on the stored document data, the preprocessing including character code normalization, removal of unnecessary symbols, and segmentation into linguistic units, and generate structured data by adding word-level and sentence-level structure information, part-of-speech information, and semantic unit information to the document data,
analyze the structured data using at least one of a statistical method and a machine learning method, extract topic classification information, feature term information, emotional state information, and stance information, and associate the topic classification information and the feature term information with each document data as analysis results,
generate, for each document data, a feature set including at least source history information, similarity information with other document data, update history information, and content consistency information, and calculate a reliability index for each document data by inputting the feature set into a trained deep learning model, and assign reliability classification information and explanation tag information to each document data based on the reliability index,
generate, for each document data, a prompt sentence for a generative AI model, the prompt sentence including at least the document data, the reliability index, and the explanation tag information, transmit the prompt sentence to the generative AI model, receive, from the generative AI model, summary information and explanation information corresponding to the prompt sentence, and associate the summary information and the explanation information with the corresponding document data as generative output,
select, based on at least the reliability index, the topic classification information, user attribute information, and user selection conditions, evaluation target document data to be provided to a user terminal, and generate response data including the selected evaluation target document data and the associated summary information and explanation information, and transmit the response data to the user terminal via the communication network, and
receive, from the user terminal, evaluation feedback information related to the evaluation target document data, record the evaluation feedback information in association with the corresponding document data, and use the evaluation feedback information as training data to update at least one of the trained deep learning model and a process for generating the prompt sentence.

### (Supplementary 2)

The system according to supplementary 1,
wherein the processor is configured to
generate the prompt sentence for the generative AI model as a structured text including at least the topic classification information, the feature term information, the reliability index, and the explanation tag information of the corresponding document data, and cause the generative AI model to generate the summary information and user-oriented reliability explanation information based on the structured text.

### (Supplementary 3)

The system according to supplementary 1,
wherein the processor is configured to
train the deep learning model using feature sets including at least semantic similarity information between document data, cross-reference information indicating presence or absence of reports from a plurality of high-reliability information sources, and the evaluation feedback information from users, and add, in generating the prompt sentence for the generative AI model, the cross-reference information and the evaluation feedback information as part of the explanation tag information so that the generative AI model generates explanation information that reflects cross-source consistency and user evaluations.

### Application Example 1

### (Supplementary 1)

A system comprising a processor,
wherein the processor is configured to function as an information collection unit that acquires, via a communication network, text data from a plurality of external information sources and communication log data from a plurality of information processing devices, and that stores the acquired data in a storage unit as structured records,
wherein the processor is configured to function as an analysis unit that performs natural language processing and statistical processing on the acquired text data and the communication log data, the natural language processing including at least tokenization, part-of-speech tagging, syntactic analysis, and phrase extraction, and the statistical processing including at least time-window aggregation and anomaly detection on the communication log data, so as to generate feature information indicating threat types, attack methods, related resources, and abnormal communication patterns,
wherein the processor is configured to function as a reliability evaluation unit that inputs the feature information into a machine learning algorithm and a deep learning algorithm trained on historical threat instances, incident occurrences, and countermeasure results, and that calculates, for each detected threat instance, a reliability score and a priority level based on at least a type of information source, a consistency of content, past reliability evaluations, an update frequency, and a degree of communication anomaly,
wherein the processor is configured to function as a countermeasure generation unit that, for a threat instance whose priority level satisfies a predetermined condition, assembles a prompt sentence including the feature information, the reliability score, and the priority level as structured data, inputs the prompt sentence into a generative AI model, and acquires, from the generative AI model, countermeasure candidates, recommended priorities, and explanatory information, and then converts the acquired countermeasure candidates into configuration change commands or control requests for network devices and information processing devices,
wherein the processor is configured to function as a countermeasure execution unit that applies the configuration change commands or the control requests to a plurality of system elements including at least access control devices, monitoring devices, and configuration management devices, so as to automatically execute security setting changes, communication path blocking, and update program application, and that records execution results in the storage unit, and
wherein the processor is configured to function as an information provision unit that generates technical explanation outputs and non-expert user-oriented outputs based on the reliability score, the priority level, and the acquired explanatory information, and that uses a prompt sentence to cause the generative AI model to generate simplified explanations for non-expert users, and provides the technical explanation outputs and the non-expert user-oriented outputs via a user interface.

### (Supplementary 2)

The system according to supplementary 1,
wherein the processor is configured to cause the information collection unit to periodically acquire, by an automatic acquisition process executed on the information processing device, text data from a plurality of types of external information sources including at least news distribution services, social information sharing services, electronic bulletin services, and record publication services, and to store the acquired text data in the storage unit with time information, source type information, and collection batch information,
wherein the processor is configured to cause the information collection unit to receive, from communication control devices and monitoring devices, communication log data and to store the communication log data in a time-series database,
wherein the processor is configured to cause the analysis unit to generate, from the text data, feature information including threat type, attack method, and related resource information by performing the natural language processing, and to generate, from the communication log data, feature information including abnormal communication patterns and statistical anomaly scores by performing the statistical processing, and
wherein the processor is configured to cause the countermeasure generation unit to construct the prompt sentence by embedding the feature information and the reliability score into a structured input format for the generative AI model and to obtain, from the generative AI model, the countermeasure candidates, the recommended priorities, and the explanatory information in response to the prompt sentence.

### (Supplementary 3)

The system according to supplementary 1,
wherein the processor is configured to cause the reliability evaluation unit to use the deep learning algorithm trained on historical data including threat instances, occurrence or non-occurrence of incidents, and effectiveness of applied countermeasures, to calculate, for each threat instance, the reliability score and the priority level based on multiple factors including at least the type of information source, the consistency of content across different sources, past reliability evaluations, information update frequency, and a degree of anomaly in associated communication data,
and wherein the processor is configured to cause the information provision unit to present information regarding a threat whose reliability score is equal to or greater than a first threshold directly to a user, and to present information regarding a threat whose reliability score is less than the first threshold together with a warning indicating a possibility that the information is erroneous and with an outline of related information from other information sources, the warning and the outline being generated by the generative AI model in response to a prompt sentence that includes a summary of the threat and the reliability score.

### Example 2

### (Supplementary 1)

A system comprising a processor,
wherein the processor is configured to function as an information collection means that acquires text information and related meta information from a plurality of external information provision units or information provision services via a network, and stores the acquired information as internal records,
wherein the processor is configured to function as a natural language processing means that performs morphological analysis, part-of-speech tagging, sentence structure analysis, keyword extraction, and document embedding generation on the acquired text information so as to obtain features representing the content of the text information,
wherein the processor is configured to function as a reliability evaluation means that, based on the features generated by the natural language processing means, attribute information including a type of information source, a domain of the information source, a history of past false information, a history of past reliability scores, an elapsed time from publication, and an information update history, and further based on similarity with other information belonging to the same or similar topic, and social reaction indicators including an emotion distribution and a degree of diffusion, calculates, by using a machine learning model, a reliability score and a reliability class for each piece of the text information and corrects the reliability score according to similarity to a known high-reliability information source or a known false information item,
wherein the processor is configured to function as a user emotion recognition means that receives, from a user terminal, at least one of a speech recognition result for audio data, a facial expression feature based on image data, and a behavioral feature based on touch operation logs, and calculates, by using an emotion estimation model, an emotion state vector including, as elements, intensities of a plurality of types of user emotions,
wherein the processor is configured to function as a generative artificial intelligence control means that, based on the reliability score and the reliability class calculated by the reliability evaluation means, the emotion state vector calculated by the user emotion recognition means, a category of the text information, and source information of the text information, generates a prompt sentence to be input to a generative AI model, inputs the prompt sentence to the generative AI model, and thereby causes the generative AI model to generate a summary sentence and a reliability explanation sentence for the text information, and
wherein the processor is configured to function as an information provision means that, in accordance with at least one of the emotion state vector obtained by the user emotion recognition means and the reliability score or the reliability class calculated by the reliability evaluation means, dynamically switches at least one of a display order, a display layout, a display color, a font, presence or absence of a warning message, and presence or absence of an operation button, for presenting, on the user terminal, the summary sentence and the reliability explanation sentence generated by the generative artificial intelligence control means and at least a part of the original text information, and outputs the switched presentation to the user terminal.

### (Supplementary 2)

The system according to supplementary 1,
wherein the processor is configured to, as the information collection means, periodically send requests, by using a network protocol and an automatic acquisition program, to a plurality of public interfaces of news distribution services, social media services, blog distribution services, and electronic bulletin board services, acquire, as responses, structured or unstructured data, and extract, from the structured or unstructured data, at least one of article body text, post body text, publication time, category information, and engagement indicators, and store the extracted information as internal unified-format records, and
wherein the processor is configured to, as the natural language processing means, perform tokenization, part-of-speech tagging, and sentence structure analysis on body texts included in the internal unified-format records, extract keywords and compound key phrases by combining a statistical method with a method based on a pre-trained language model,
generate a vector representation by using a document embedding model, and classify opinion clusters by performing similarity calculation and clustering based on the vector representation.

### (Supplementary 3)

The system according to supplementary 1,
wherein the processor is configured to, as the generative artificial intelligence control means, generate the prompt sentence for the generative AI model in such a manner that the prompt sentence explicitly specifies an output format and a writing style according to at least one of an anxiety component, an anger component, an interest component, and a joy component included in the emotion state vector and according to the reliability score and the reliability class of the text information,
wherein the processor is configured to, when the anxiety component of the user exceeds a predetermined value, include, in the prompt sentence, instructions that the generative AI model generate a short summary in a neutral tone that does not excessively increase user anxiety, explain a reason why the reliability is evaluated as medium or low based on source attributes, a degree of agreement with other information sources, and uncertainty factors, and recommend that the user confirm information provided by public information sources or other trusted sources,
wherein the processor is configured to, when the anger component of the user exceeds a predetermined value, include, in the prompt sentence, instructions that the generative AI model avoid aggressive expressions and summarize factual relationships while presenting multiple viewpoints, and
wherein the processor is configured to, when the interest component of the user exceeds a predetermined value and the reliability score is high, include, in the prompt sentence, instructions that the generative AI model provide detailed background explanations and references to related high-reliability information, input the prompt sentence to the generative AI model to cause generation of the summary sentence and the reliability explanation sentence, and present generation results to the user terminal via the information provision means.

### Application Example 2

### (Supplementary 1)

A system comprising a processor,
wherein the processor is configured to
acquire, via a communication line, external information and communication records from an external information source and a communication device, normalize the acquired external information and communication records into a structured format, and store the normalized external information and communication records in a storage unit as collected data, analyze text data included in the collected data by performing character string segmentation processing, lexical classification processing, and semantic analysis processing, extract a text document including a term related to information security, and estimate a type and a feature of a security threat on the basis of the text data and the communication records as natural language processing,
input, into a trained numerical computation model, attribute values including a type of the external information source, a past attack case, an abnormality degree based on the communication records, and a past reliability evaluation as feature amounts, calculate, for each security threat, a threat reliability index indicating an occurrence possibility of the security threat, and classify the security threat into a plurality of priority levels on the basis of the threat reliability index as reliability evaluation,
acquire at least one of operation history information of a user and biometric information of the user from a terminal, input a time-series pattern and an expression feature contained in the operation history information and the biometric information into a trained numerical computation model, estimate, as an emotion state index, at least a stress degree, an anxiety degree, an attention decrease degree, and a fatigue degree of the user, and record the emotion state index in the storage unit as emotion recognition,
refer to the threat reliability index and the emotion state index, select a template from a plurality of templates stored in the storage unit, embed technical information regarding the security threat and attribute information regarding the user into the selected template to construct a prompt sentence as a generation input sentence, transmit the prompt sentence to a generative AI model via an application programming interface, and acquire a response text generated by the generative AI model as generative AI cooperation, and
control, on the basis of the response text and the threat reliability index, at least one of a setting change of a network device, a setting change of an information processing device, isolation of an electronic message, and display of warning information in an automatic or semi-automatic manner, and present the response text to at least one of the user and an administrator as information provision.

### (Supplementary 2)

The system according to supplementary 1,
wherein the processor is configured to
execute crawl processing that periodically transmits a request signal to a plurality of information providing entities on a network, acquire text data and structured data from a plurality of types of information sources including a news distribution service, an information providing service, an electronic bulletin board, and a social information sharing service, acquire communication records including a source identifier, a destination identifier, communication control information, and time information from the communication device,
perform word segmentation processing, word classification processing, sentence structure analysis processing, and document embedding vector generation processing on the text data as natural language processing, and generate feature amounts to be input to the reliability evaluation.

### (Supplementary 3)

The system according to supplementary 1,
wherein the processor is configured to
when the threat reliability index is equal to or greater than a first threshold and at least one of the stress degree and the anxiety degree included in the emotion state index is equal to or greater than a second threshold, select a template that instructs generation of an explanation output emphasizing reassurance, construct, as the prompt sentence for the generative AI model, a sentence that instructs generation of an explanation text including a non-blaming tone toward the user, enumeration of key dangerous points, and a concluding phrase that promotes reassurance, and, when the threat reliability index is equal to or greater than a third threshold and the attention decrease degree is equal to or greater than a fourth threshold,
append control information for causing the information provision to preferentially execute an automatic countermeasure related to the security threat.

What is claimed is:

1. A system comprising:
circuitry configured to:
acquire, via a communication interface coupled to a packet-switched network, a plurality of data objects and associated attribute data from a plurality of networked data sources, and store the data objects with temporal metadata and source identification data in a memory;
preprocess the stored data objects to generate enriched data records comprising structure information and semantic annotations;
apply a trained classification model to the enriched data records to extract feature information and associate the feature information with corresponding data objects;
compute, using a trained neural network model, a confidence score for each data object based on a feature set derived from the feature information, and assign a classification label to each data object based on the confidence score;
construct an input prompt for each data object comprising at least the data object and the confidence score, transmit the input prompt to a generative language model, and receive a generated output comprising a summary output and an explanatory output;
select a subset of the data objects based on the confidence score, generate response data comprising the selected subset and the associated generated output, and transmit the response data to a client terminal via the packet-switched network; and
receive feedback data from the client terminal and update the trained neural network model based on the feedback data.

2. The system according to claim 1, wherein the circuitry is configured to preprocess the stored data objects by performing character code normalization, removal of unnecessary symbols, and segmentation into linguistic units, and to generate the enriched data records by adding word-level structure information, sentence-level structure information, part-of-speech information, and semantic unit information to the data objects.

3. The system according to claim 2, wherein the circuitry is configured to apply the trained classification model to extract the feature information comprising topic classification information, key term information, emotional state information, and stance information.

4. The system according to claim 3, wherein the feature set comprises source history information, cross-object similarity information, temporal update information, and content consistency information.

5. The system according to claim 1, wherein the circuitry is configured to assign the classification label and an explanation tag to each data object based on the confidence score, and to include the explanation tag in the input prompt transmitted to the generative language model.

6. The system according to claim 5, wherein the circuitry is configured to construct the input prompt as a structured text comprising at least topic classification information, key term information, the confidence score, and an explanation tag associated with the corresponding data object, and to cause the generative language model to generate the summary output and a user-oriented explanation based on the structured text.

7. The system according to claim 6, wherein the circuitry is configured to select the subset of the data objects based on at least the confidence score, topic classification information, user attribute information, and user selection conditions.

8. The system according to claim 1, wherein the circuitry is configured to acquire the plurality of data objects from the networked data sources comprising at least news distribution services, social information sharing services, electronic bulletin services, and record publication services.

9. The system according to claim 1, wherein the circuitry is configured to compute the confidence score by training the trained neural network model using feature sets comprising semantic similarity information between data objects, cross-reference information indicating presence or absence of reports from a plurality of high-confidence data sources, and the feedback data from the client terminal.

10. The system according to claim 1, wherein the circuitry is configured to acquire, via the communication interface, communication log data from a plurality of network devices, and to perform statistical processing on the communication log data comprising time-window aggregation and anomaly detection to generate anomaly feature data.

11. The system according to claim 10, wherein the circuitry is configured to generate, for each detected anomaly, a composite feature vector combining the anomaly feature data and text-derived feature information, input the composite feature vector into the trained neural network model, and compute a priority level based on the confidence score.

12. The system according to claim 10, wherein the circuitry is configured to generate, based on the confidence score and the priority level, configuration change commands for at least one of an access control device, a monitoring device, or a configuration management device, and to transmit the configuration change commands via the communication interface.

13. The system according to claim 1, wherein the circuitry is configured to receive, from the client terminal, emotion state data estimated from at least one of audio data, image data, or behavioral interaction data, and to select a prompt template for the input prompt based on the emotion state data and the confidence score.

14. The system according to claim 13, wherein the emotion state data comprises intensity values for a plurality of emotion categories, and the circuitry is configured to compare each intensity value against a corresponding threshold to determine a user emotional condition, and to select the prompt template based on a combination of the user emotional condition and the classification label.

15. The system according to claim 1, wherein the circuitry is configured to generate the response data comprising a layout parameter determined based on the confidence score and user attribute information, and to transmit the layout parameter to the client terminal for adaptation of a display format of the summary output and the explanatory output.

16. The system according to claim 1, wherein the circuitry is configured to encode the data objects using a transformer-based language model to compute document embedding vectors, and to compute the cross-object similarity information by calculating cosine similarity between the document embedding vectors.

17. The system according to claim 1, wherein the circuitry is configured to transmit the input prompt to the generative language model with generation parameters comprising a maximum token count, a temperature value, and a decoding method, and to parse the generated output to separate the summary output and the explanatory output based on structural markers in the generated output.

18. A system comprising:
a communication interface coupled to a packet-switched network;
a processor;
a random access memory; and
a non-volatile storage device storing a processing program, a neural network model, and a generative language model, wherein the processor executes the processing program loaded into the random access memory to:
acquire, via the communication interface, a plurality of data objects and associated attribute data from a plurality of networked data sources, and store the data objects with temporal metadata and source identification data in the non-volatile storage device; preprocess the stored data objects by performing tokenization, part-of-speech tagging, and syntactic analysis to generate enriched data records;
extract feature information from the enriched data records using the neural network model and compute a confidence score for each data object;
construct an input prompt comprising the data object, the confidence score, and an explanation tag, transmit the input prompt to the generative language model, and receive a generated output comprising a summary output and an explanatory output;
generate response data comprising a selected subset of data objects and the associated generated output, and transmit the response data to a client terminal via the packet-switched network; and
receive feedback data from the client terminal and update the neural network model based on the feedback data.

19. The system according to claim 18, wherein the processor is further configured to acquire communication log data from a plurality of network devices via the communication interface, perform anomaly detection on the communication log data, and compute a priority level for each data object based on the confidence score and anomaly detection results.

20. A method performed by circuitry of a system, the method comprising:
acquiring, via a communication interface coupled to a packet-switched network, a plurality of data objects and associated attribute data from a plurality of networked data sources, and storing the data objects with temporal metadata and source identification data in a memory;
preprocessing the stored data objects to generate enriched data records comprising structure information and semantic annotations;
applying a trained classification model to the enriched data records to extract feature information;
computing, using a trained neural network model, a confidence score for each data object based on a feature set derived from the feature information;
constructing an input prompt for each data object, transmitting the input prompt to a generative language model, and receiving a generated output comprising a summary output and an explanatory output;
selecting a subset of the data objects based on the confidence score, generating response data, and transmitting the response data to a client terminal via the packet-switched network; and
receiving feedback data from the client terminal and updating the trained neural network model based on the feedback data.
